(19) United States
(12) Patent Application Publication
(10) Pub. No.: US 2002/0079022 A1
(43) Pub. Date: Jun. 27, 2002

(54) Machining systems and methods for forming non-metallic parts

(76) Inventor: Paolo M. Colle, Charlotte, NC (US)

Correspondence Address: Christopher L. Bernard, Kilpatrick Stockton LLP, 3500 One First Union Center, 301 South College Street, Charlotte, NC, 28202-6001, US

(21) Appl. No.: 10/032,891

(22) Filed: Dec. 26, 2001

Related U.S. Application Data
(60) Provisional application No. 60/258,432, filed on Dec. 27, 2000.

(51) Int. Cl. B27C 1/00; B23Q 16/00; B23Q 15/00; B27C 5/00; B27G 13/00

(52) U.S. Cl. 144/382; 144/218

(57) ABSTRACT

A machining system and an associated method for forming a non-metallic part including a headstock assembly and a tailstock assembly, the headstock assembly and the tailstock assembly being axially aligned along a headstock-tailstock axis, the headstock assembly and the tailstock assembly together operable for rotatably supporting the part. The system also including a base operable for movably supporting the headstock assembly and the tailstock assembly. The system further including at least one accessory carrier movably coupled to the base, the at least one accessory carrier including at least one accessory operable for assisting in the loading, stabilizing, and unloading of a workpiece. The system further including a plurality of tool changers movably coupled to the base, each of the plurality of tool changers including a plurality of tools operable for machining surfaces of the workpiece and forming the part. The system further including a controller operable for directing the machining system to form the part.

### CROSS-REFERENCE TO RELATED APPLICATIONS

This patent application claims the benefit of U.S. Provisional Patent Application No. 60/258,432, filed Dec. 27, 2000, which is hereby incorporated in full by reference.

### FIELD OF THE INVENTION

The present invention relates generally to machining systems and methods for forming non-metallic parts and, more specifically, to a computer-controlled machining center and associated methods for forming non-metallic parts.

### BACKGROUND OF THE INVENTION

The machinery and associated methods utilized to turn and form non-metallic parts, such as wooden parts for furniture and the like, are typically very specialized. For example, many of the machines are designed and optimized to perform only a single operation on one or more wooden parts. As a result, a wooden part may undergo numerous operations on numerous different machines before being formed into its final dimensions. Additionally, each machine typically has its own unique fixturing, thereby eliminating any chance of automating the process between machines and/or operations. Further, to make up for their inefficiencies, some machines perform an operation in series on a single part or on a number of parts. If there is a problem with one of these serial operations, the problem affects the remaining serial devices. These specialized machines and methods may optimize a given operation, but taken as a whole, they are responsible for a great amount of inefficiency in the processing of each wooden part. For example, moving the wooden part in and out of a machine typically involves set-up/tear-down time for loading, chucking, positioning, unchucking, and unloading the part. After taking into consideration the various set-up/tear-down times for each special machine utilized to produce a given wooden part, or the various wooden parts needed to assemble a piece of furniture or the like, one finds that the cost of producing the part involves a tremendous amount of time that has been inefficiently spent on these set-up/tear-down procedures.

Further, some prior art devices have attempted to utilize the multi-axis machining centers typically found for manufacturing metallic parts to perform more than one operation on a non-metallic part. However, these attempts at adapting metal working machinery have a number of drawbacks. For instance, in machines that utilize metal tool turrets having numerous tools on the turret, the prior art devices do not utilize high frequency spindles on the rotating tools, and thus the tools cannot achieve the high rotation speeds necessary to effectively produce wooden parts. Additionally, these devices require special fixturing, thereby requiring inefficient set-up and tear-down operations while eliminating the practical automation of the device.

Thus, a machine is needed that is capable of performing multiple operations on a non-metallic part, or on numerous different non-metallic parts, so that the part or parts may be completely finished by the single machine without the need for further, specialized machining operations.

### BRIEF SUMMARY OF THE INVENTION

Recognizing the deficiencies of the prior art, the present invention provides systems and methods for efficiently producing one or a plurality of non-metallic parts, where all surfaces of the part or parts are finished by the system.

In one embodiment of the present invention, a machining system for forming a non-metallic part includes a headstock assembly and a tailstock assembly, the headstock assembly and the tailstock assembly being axially aligned along a headstock-tailstock axis, the headstock assembly and the tailstock assembly together operable for rotatably supporting the part. The system also includes a base operable for movably supporting the headstock assembly and the tailstock assembly. The system further includes at least one accessory carrier movably coupled to the base, the at least one accessory carrier including at least one accessory operable for assisting in the loading, stabilizing, and unloading of a workpiece. The system further includes a plurality of tool changers movably coupled to the base, each of the plurality of tool changers including a plurality of tools operable for machining surfaces of the workpiece and forming the part. The system further includes a controller operable for directing the machining system to form the part.

### BRIEF DESCRIPTION OF THE DRAWINGS

The figures discussed herein include various views of the system and the system components of the present invention. The figures discussed herein also illustrate the methods of the present invention.

FIG. 1 is a perspective view of one embodiment of the machining system for forming non-metallic parts of the present invention;

FIG. 2 is another perspective view of the system of FIG. 1;

FIG. 3 is a cross-sectional side view of the system of FIG. 1;

FIG. 4 is a further perspective view of the system of FIG. 1, highlighting the support structure of the system;

FIG. 5 is a perspective view of another embodiment of the support structure of the system of FIG. 1;

FIG. 6 is a cross-sectional side view of the support structure of FIGS. 4 and 5, and the system of FIG. 1;

FIG. 7 is a perspective view of one embodiment of a movable carriage of the system of FIG. 1;

FIG. 8 is a cross-sectional view of the carriage of FIG. 7;

FIG. 9 is another cross-sectional view of the carriage of FIG. 7;

FIG. 10 is a further perspective view of the system of FIG. 1;

FIG. 11 is a perspective view of one embodiment of a headstock/tailstock assembly of the system of FIG. 1;

FIG. 12 is a side view of the headstock/tailstock assembly of FIG. 11;

FIG. 13 is a cross-sectional view of the headstock/tailstock assembly of FIG. 11;

FIG. 14 is a perspective view of one embodiment of an accessory carrier of the system of FIG. 1;

FIG. 15 is another perspective view of the accessory carrier of FIG. 14;

FIG. 16 is a further perspective view of the accessory carrier of FIG. 14;

FIG. 17 is a further perspective view of the accessory carrier of FIG. 14;

FIG. 18 is a further perspective view of the accessory carrier of FIG. 14;

FIG. 19 is a perspective view of one embodiment of a tool changer of the system of FIG. 1;

FIG. 20 is another perspective view of the tool changer of FIG. 19;

FIG. 21 is a side view of the tool changer of FIG. 19;

FIG. 22 is a cross-sectional side view of the tool changer of FIG. 19;

FIG. 23 is a perspective view of one embodiment of a mount for movably securing the tool changer of FIG. 19;

FIG. 24 is a perspective view of one embodiment of a conveyor assembly of the system of FIG. 1;

FIG. 25 is another perspective view of the conveyor assembly of FIG. 24;

FIG. 26 is a further perspective view of the conveyor assembly of FIG. 24;

FIG. 27 is a side view of the conveyor assembly of FIG. 24;

FIG. 28 is a perspective view of one embodiment of a housing of the system of FIG. 1;

FIG. 29 is a perspective view of one embodiment of a panel of the housing of FIG. 28;

FIG. 30 is a side view of the housing of FIG. 28;

FIG. 31 is a rear view of the housing of FIG. 28;

FIG. 32 is a schematic diagram of one embodiment of a control system for the system of FIG. 1;

FIG. 33 is a perspective view of another embodiment of the machining system for forming non-metallic parts of the present invention; and

FIG. 34 is a side view of the system of FIG. 33.

### DETAILED DESCRIPTION OF THE INVENTION

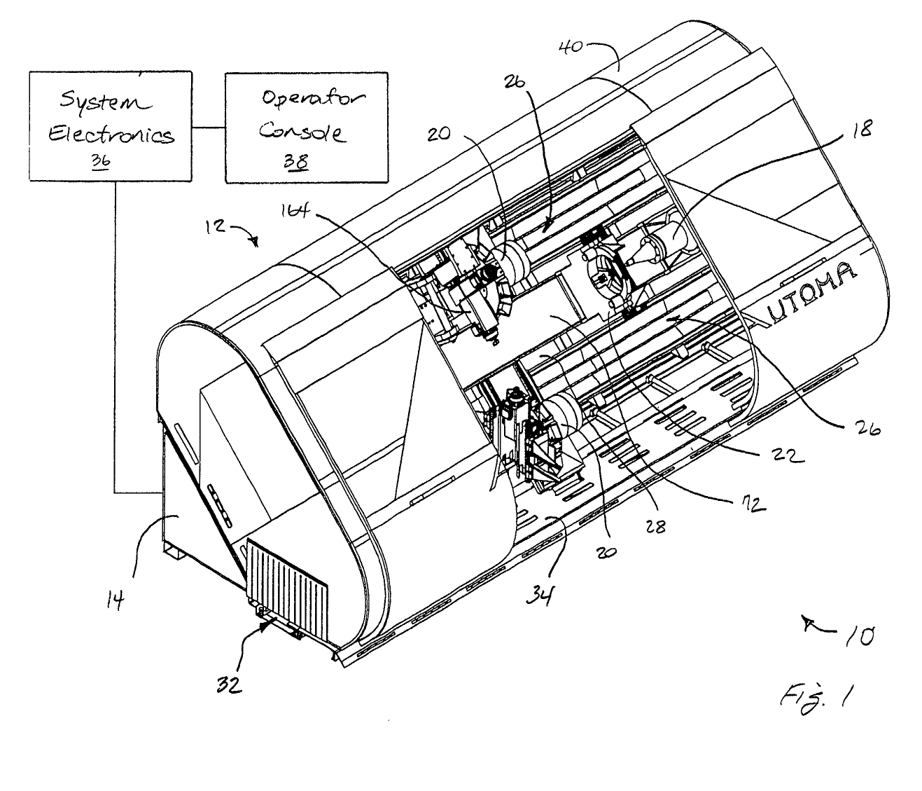

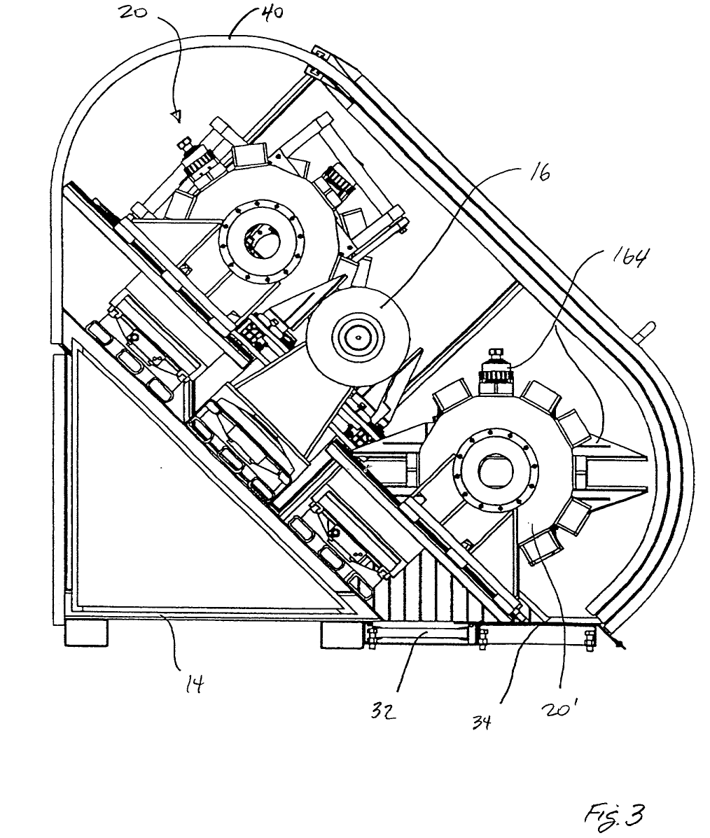

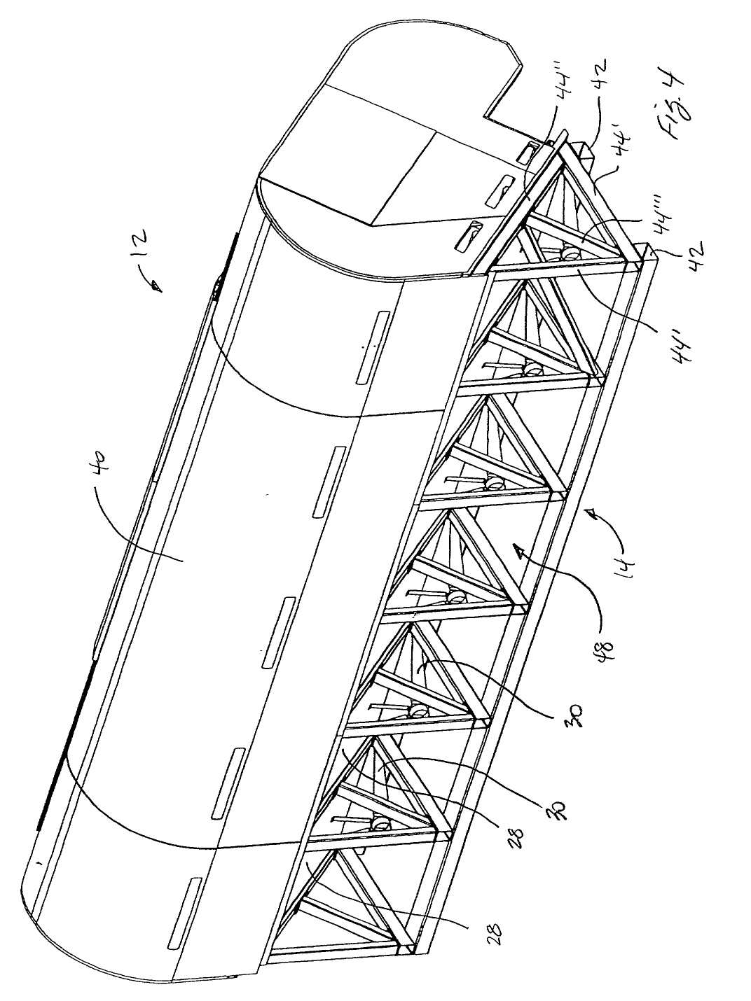

According to one embodiment of the present invention, referring to FIGS. 1-4, a machining system 10 includes a machine 12 having a base 14 movably supporting each of an axially-aligned headstock assembly 16 and tailstock assembly 18 used for holding and rotating a workpiece, such as a non-metallic part. Further, the base 14 movably supports a plurality of tool changers 20, such as a first tool changer 20 positioned on a first side of the headstock-tailstock axis and a second tool changer 20′ positioned on a second side of the headstock-tailstock axis, i.e. on the opposite side of the headstock-tailstock axis. Additionally, one or more accessory carriers 22 may be movably supported by the base 14, where the accessory carriers 22 include, for example, tables, steady-rests, and clamps used to assist in the loading, stabilizing/machining, and unloading of workpieces. Each of the headstock 16, tailstock 18, tool changers 20 and 20′, and accessory carriers 22 are mounted on one of a plurality of carriages 24 that travel on one of a plurality of guide assemblies 26 that longitudinally extend across the base 14. One or more collector plates 28 are positioned under the guide assemblies 26 to collect dust, chips, and other debris and direct them to one or more dust collection funnel assemblies 30 (FIG. 4). A conveyor system 32, positioned to longitudinally extend between the front foot of the base 14 and an operator platform 34, collects and carries away chips and other debris, and also transports a workpiece to or from the machine 12. The collector plates 28, funnel assemblies 30, and conveyor belt 32 form part of a dust/chip/debris collection system that may be integrated into a central vacuum system. The system electronics 36 may be stored within the structure of the base 14, while an operator console 38 is used to control operation of the system 10. The system electronics 36 and operator console 38 form a controller, such as a computer system, that includes the appropriate hardware, software, and associated components for integrating the operations of the various components of the system 10 to finish a workpiece. Most of the components of the system 10, with the exception of, for example, the operator console 38, are enclosed within a housing system 40 that includes a plurality of covers and doors. The housing system 40 is insulated to dampen any noise within the system 10 and, further, the housing system 40 provides a sealed environment having an internal airflow for the collection of dust, chips, and other debris.

Thus, the machining system 10 includes a computer-controlled woodworking machine 12 having a headstock 16 and tailstock 18 for rotatably supporting a workpiece, automatically loaded and unloaded by the system 10, while a plurality of tools mounted on a plurality of tool changers 20 and 20′ machine all surfaces of the workpiece to form a finished part, all within an insulated and sealed housing system 40 that collects dust, chips, and other debris and dampens noise.

The workpiece finished by system 10 may be made of any non-metallic material, such a wood, a ceramic material, plastic, carbon fiber, fiberglass, a composite material, or any other relatively soft, non-metallic, non-ferrous material. The machining system 10 is capable of finishing all surfaces of the workpiece, including all 6 axes/sides of the workpiece, and including boring holes at any angle into any surface of the workpiece.

The machine base 14 may advantageously include a slant-bed design to aid in dust/chip/debris collection, to facilitate operator loading/unloading, and to optimize/minimize the footprint of the machine. The slant-bed design includes a mounting bed lying at any angle between about 0 degrees and about 90 degrees with respect to a horizontal axis, such as a floor. Preferably, the base 14 forms an angled bed in the range of about 10 degrees to about 80 degrees from the horizontal axis, more preferably in the range of about 25 degrees to about 65 degrees, and most preferably in the range of about 35 degrees to about 55 degrees. In practice, the most preferred slant-bed angle is about 45 degrees, thereby allowing dust, chips, and debris to fall and be centrally collected, as well as allowing for gravitational unloading of workpieces. Alternatively, the base 12 may form a horizontal or vertical platform on which the remaining system components may be mounted.

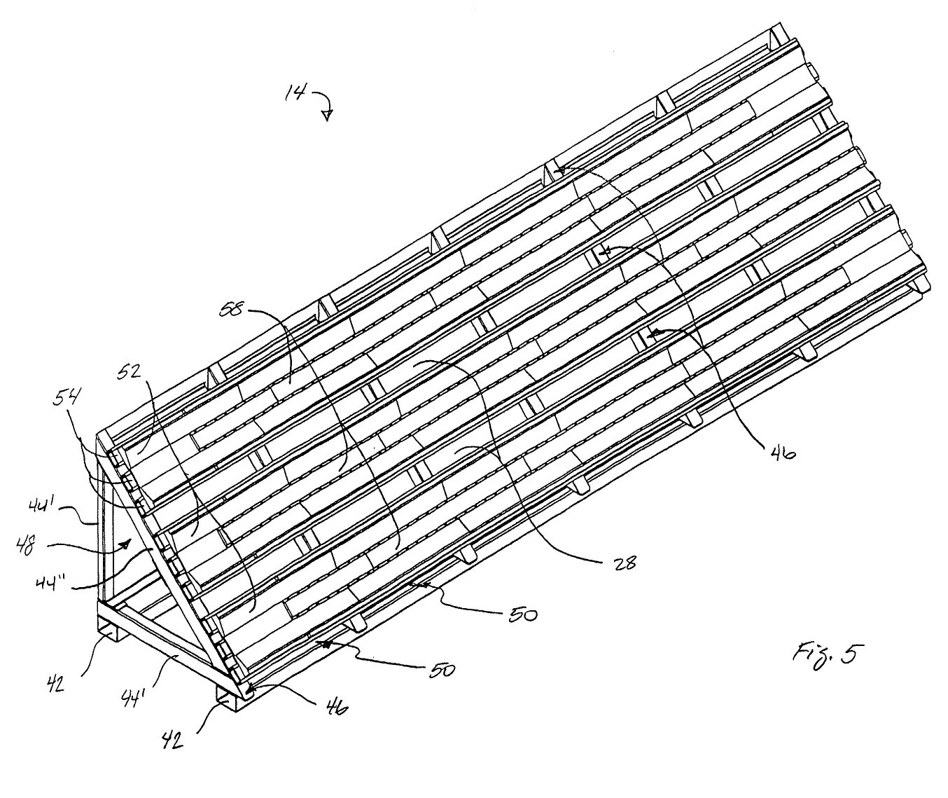

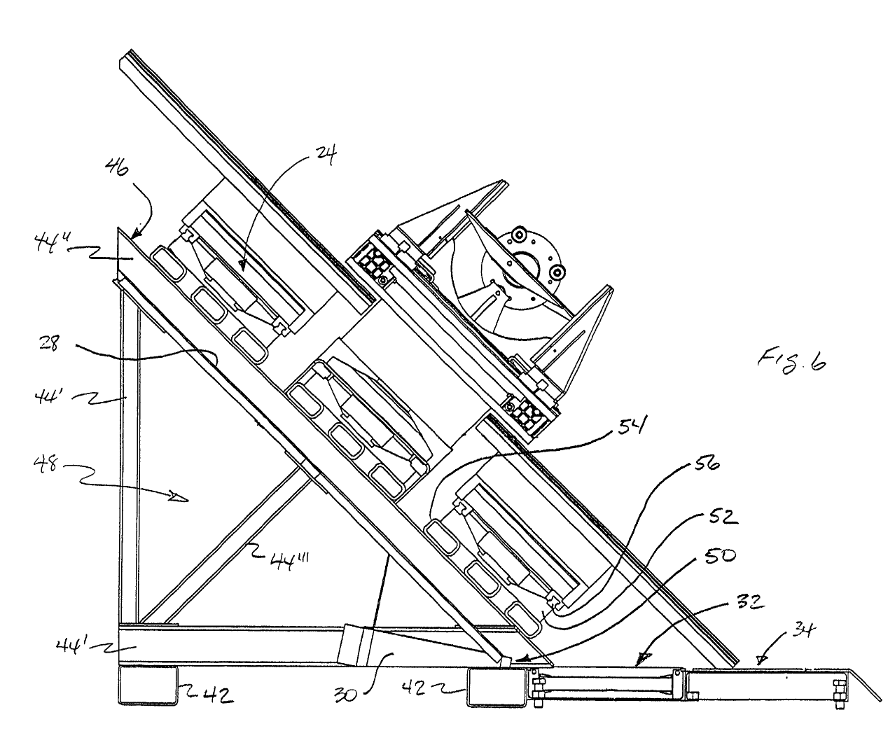

Referring to FIGS. 4-6, for example, one embodiment of the base 14 includes a plurality of modular assemblies forming an easily-expandable base assembly. The base 14 includes front and rear longitudinally extending members 42 that support a plurality of triangular assemblies 44. The triangular assemblies 44 include side frame members 44′, a bed frame member 44″, and a cross-brace member 44′″ (FIG. 4) forming a triangular frame. The triangular frame is preferably an equilateral triangle, such that the bed or mounting surface 46 of the base 14 is at about a 45 degree angle to the floor. The triangular frame advantageously allows the system 10 to have a compact depth and height. Further, the triangular frame provides a storage space 48 within the frame, opposite the mounting surface, for storage of system electronics, debris collection systems, and other components of the machine 12. The front and rear longitudinally extending members 42 and the triangular assemblies 44 may be constructed of any material capable of supporting the weight and forces of the system 10, such as metals, plastics, and composites. Optionally, the members 42 and assemblies 44 are constructed of tubular steel.

Additionally, the collector plate 28 is mounted to the underside of, or between, adjacent bed frame members 44″, extending the longitudinal length between the frame members 44″ as well as almost the entire vertical height of the members 44″. The collector plate 28 may include one or a plurality of sheets of material, such as a plastic, composite, or metal. The collector plate 28 is somewhat shorter in vertical height than bed frame members 44″ to form an aperture 50 at the bottom end of the machine 12 between the end of the collector plate 28 and the front longitudinally extending member 42. The aperture 50 is sized to allow the passage of dust and/or chips and/or debris gathered by the collector plate 28 into the sealingly connected funnel assemblies 30 (FIG. 4), which may in turn be connected to a central vacuum system.

One or more rail mounting plates 52 may be attached to a plurality of rail frame supports 54 secured to the mounting surface 46. Rails 56 are mounted at the edges of the rail mounting plates 52. The rails 56 may longitudinally extend any length, preferably the full length of the machine 12. The combination of the rails 56 and the rail mounting plates 52 provides a predetermined travel path for the carriages 24. It should be noted that structures that provide a predetermined travel path may be utilized in the place of rail mounting plates 52 and rails 56. Additionally, the rail mounting plates 52 may include positioning and/or stabilizing components 58 for assisting the movement and positioning of the carriages 24, as is discussed below in more detail. The rail mounting plates 52, rail frame supports 54, and rails 56 may be constructed of materials similar to those discussed above for the longitudinally-extending members 42 and the triangular assemblies 44.

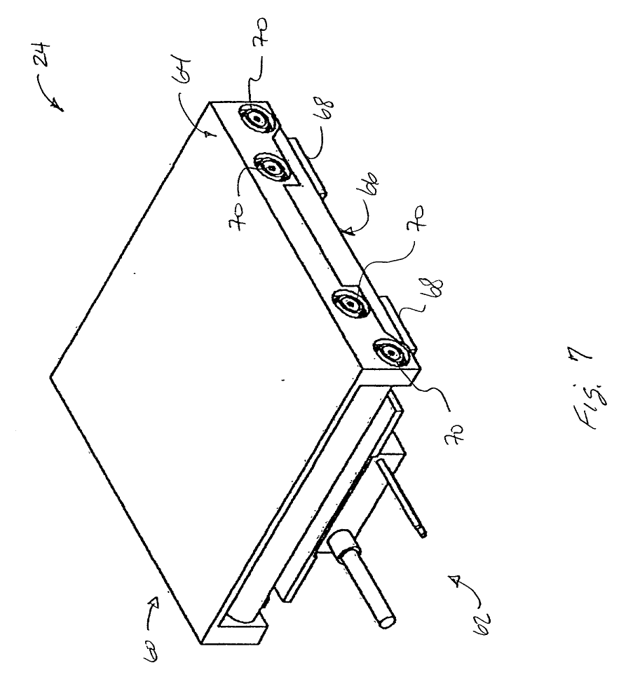

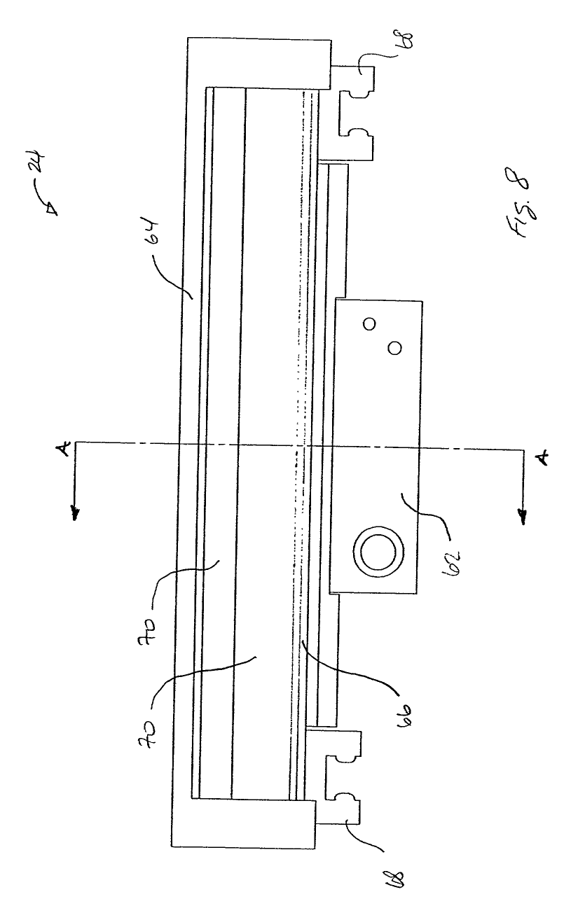

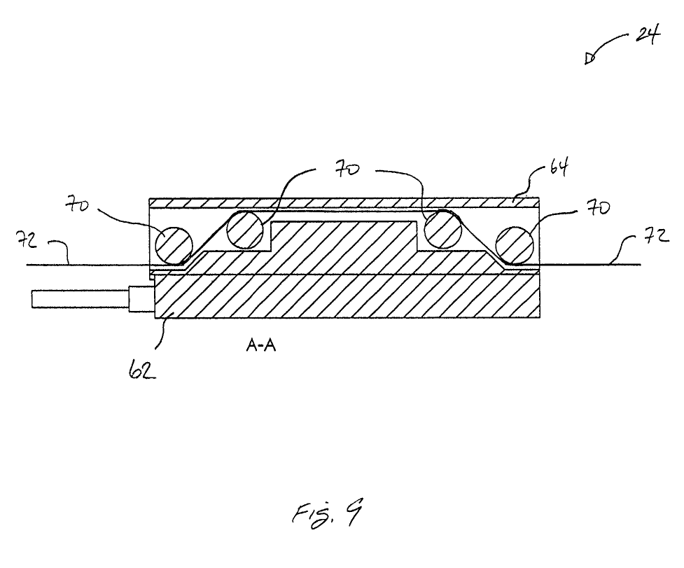

Referring to FIGS. 7-9, one or more carriages 24 may be movably attached to the predetermined travel path provided by, for example, the rails 56. Each carriage 24 includes a housing 60 and carriage positioning components 62 that interact with the positioning components 58 of the mounting plates 52. The housing 60 has a top plate 64 having a mounting surface for mounting various system components, such as tool changers 20 and 20′, and a bottom plate 66 having a bottom surface for mounting travel guide components, such as bearing blocks 68 that interact with the rails 56. The carriage and mounting plate positioning components 62 and 58 form a linear drive system. Suitable examples of linear drive systems include, but are not limited to, linear motors, gear systems, belt/cable systems, tread systems, wheeled systems, electrical systems, hydraulic systems, and magnetic systems, etc.

In one embodiment of the present invention, the linear drive system includes a magnetic drive linear motor, such as a DIAX04 series motor manufactured by Manesman Rexroth Indramat. Other manufacturers of similar magnetic drive linear motors include, for example, Anorad and Siemens. In the magnetic drive linear motor embodiment, carriage and mounting plate positioning components 62 and 58 include an opposing magnetic and electrical drive apparatus, including braking components. Magnetic-type linear motor systems advantageously provide an extremely high acceleration and high velocity, as well as extremely fast braking and accurate positioning, when compared to traditional motor systems. The braking system and the positioning system, for example, may be independent systems or they may be integrated into the motor system. For example, the carriage 24 with a magnetic drive linear motor may have an acceleration in the range of greater than zero to about 5 g, more preferably in the range of about 0.5 g to about 4 g, and most preferably in the range of about 1 g to about 3 g. In one embodiment of the present invention, for example, a linear motor system drives the carriage 24 at speeds up to about 3 meters/second, with acceleration up to about 3 g, and with a force up to about 30,000 N. The speed of a magnetic drive linear motor therefore allows for the quick positioning of any components mounted to the carriage 24, thereby reducing manufacturing time.

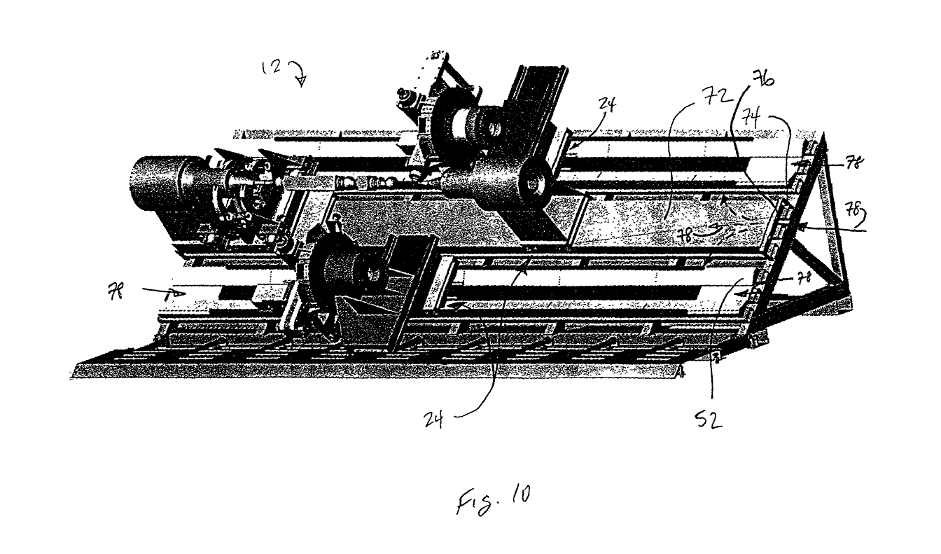

In another embodiment of the present invention, referring again to FIGS. 7-9 and to FIG. 10, the housing 60 supports a series of support devices 70 that carry, for example, a flexible cover 72 that longitudinally extends the length of the machine 12 over the predetermined travel path of the carriage 24. The support devices 70 may include, for example, rollers, protruding tabs, pins, and other similar mechanisms. For example, the support devices 70 may be positioned at the longitudinal ends of the carriage 24, supported within the top plate 64 or alternatively the bottom plate 66, holding the cover 72 down at the ends, close to the base components supporting the carriage 24 and forming the predetermined travel path, while supporting the cover 72 above any components positioned within the housing 60. The cover 72 is fixed at both ends of the predetermined travel path, such as by mounting brackets 74 positioned at the ends of each mounting plate 52, and extends in all directions to shield the entire predetermined travel path from dust, chips, and debris. As such, one or more carriages 24 may move along a predetermined travel path while the flexible cover 72 passes through the support devices 70, enabling each cover 72 to form a shield over each predetermined travel path to prevent any debris from accumulating within the predetermined travel path. Suitable materials for the forming cover 72 include, for example, mylar, thin metals, rubbers, elastomers, plastics, and any other flat, planar, sheet-like material capable of being supported substantially in a plane above the predetermined travel path and passing through a carriage 24. As opposed to being completely flat, for example, a cover 72 may further include downwardly extending flanges at the edges and may pass straight through the carriage 24.

In order to assist the cover 72 in keeping dust, chips, and debris away from the predetermined travel path of the carriages 24, the mounting brackets 74 positioned at the ends of each mounting plate 52 also may form a gas intake 76 for air or another gas 78 to be forced into the chamber formed by the cover 72 and the mounting plate 52. The gas 78 flows longitudinally within the chamber, under the cover 72, and escapes along the longitudinal gaps at the edges between the cover 72 and the rails 56 and/or mounting plate 52. As a result, a positive airflow exits from under the cover 72, with the force of the moving air or gas 78 repelling dust, chips, and debris away from the predetermined travel path. The flow of gas or air 78 may be supplied, for example, through conduits from external blowers, such as may be associated with a central vacuum system in a factory, or through an internal blower/vacuum system within the system 10.

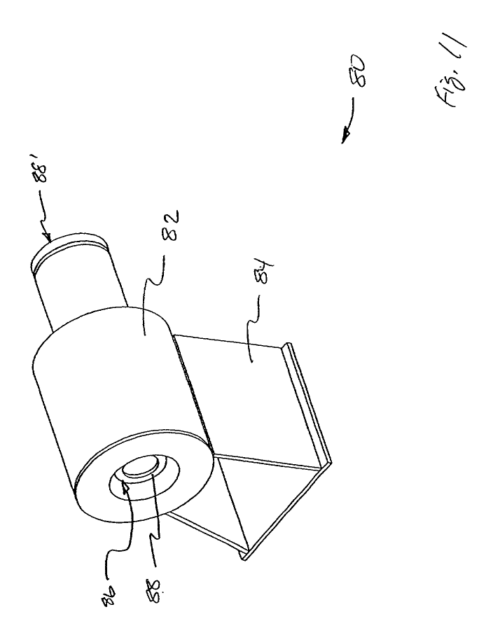

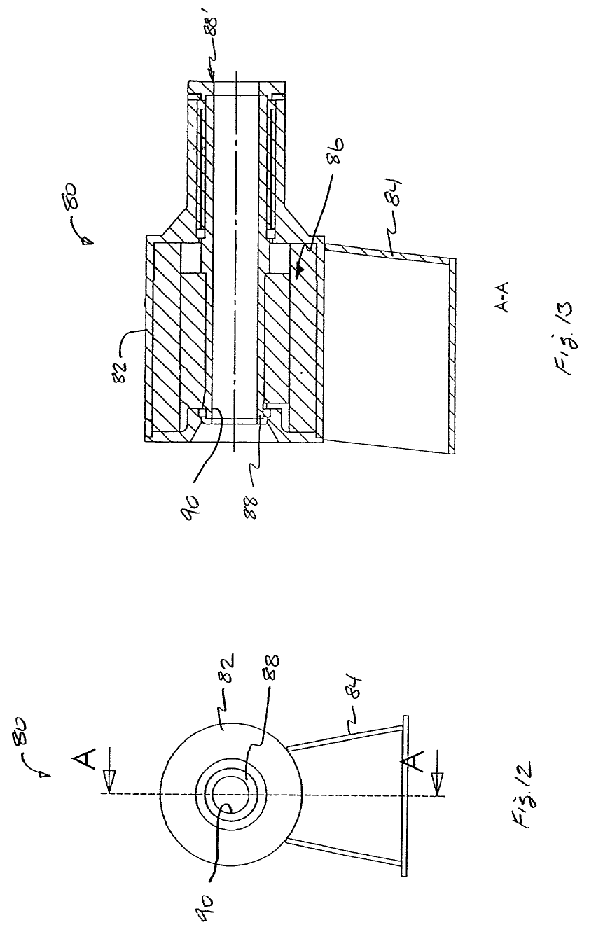

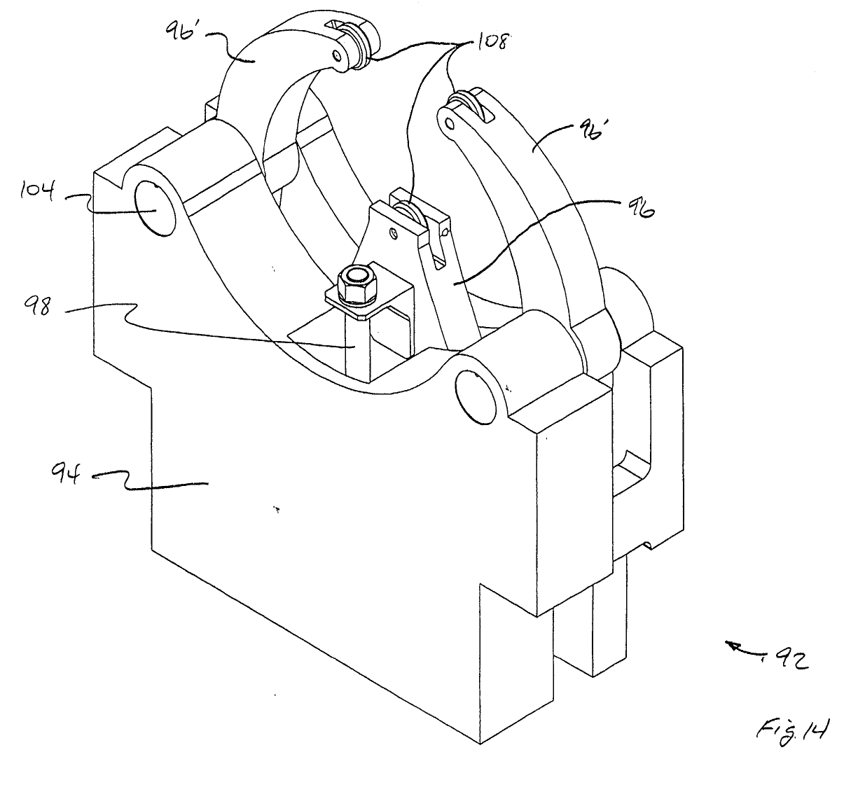

Referring to FIGS. 11-13, a headstock/tailstock assembly 80 includes a housing 82 supported on a base 84 for mounting to, for example, a carriage 24 (not shown). The headstock/tailstock assembly 80 may be configured to form a headstock 16 or a tailstock 18. For example, the headstock/tailstock assembly 80 including a motor may form a headstock 16, while a motor-less version forms a tailstock 18. In another example, the headstock/tailstock assembly 80 may be configured with one or more motors, where a motorized tailstock 18 is utilized as a sub-spindle for holding and performing operations on a workpiece that has been separated from the main spindle or motorized headstock 16. Thus, two workpieces, one held by the headstock 16 and the other held by the tailstock 18, each possibly also being held by a steady-rest accessory, may be operated on at once by the system 10. Alternatively, separate, non-modular headstock and tailstock assemblies 16 and 18 may be utilized. In one embodiment of the present invention, the headstock/tailstock assembly 80 has a housing 82 that is a longitudinally extending, cylindrical shape. A motor 86 having a rotatable shaft 88 is mounted within the housing 82, where at least one end 88′ of the shaft is adapted for mounting various standard workpiece-holding devices. For example, such workpiece-holding devices may include, but are not limited to, spur chucks, collets, jaw chucks, vacuum chucks, etc. Suitable examples of a motor 86 include electro-magnetic motors, electric motors, magnetic motors, servo-motors, frameless motors, and any other type of motor capable of rotating at variable speeds suitable for woodworking, i.e. in the range of about greater than zero to about 10,000 rpm, more preferably in the range of greater than zero to about 6,000 rpm, and capable of being accurately indexed to a given rotational position. The variable rotational speed depends on the diameter of the workpiece and the operation being performed. Preferably, motor 86 is servo-motor with an integral braking and positioning mechanism, such as a DIAX04 series frameless, digital servo-, direct-drive motor manufactured by Manesman Rexroth Indramat. Such a motor includes direct drive capabilities for positioning at any point in 360 degrees, rotational speeds of up to about 8000 rpm, and torques of up to about 260 N-m. The motor 86 may include a separate or integrated feedback system, including for example a linear and/or a rotary encoder, for use in controlling the motor 86. As mentioned above, the specifications of a motor 86 utilized in the headstock 16 may vary from the specifications of the motor utilized in the tailstock 18, depending on the operating environment.

The shaft 88 may be a solid shaft or a hollow shaft, preferably formed from a material such as a metal able to withstand the high forces involved with holding and rotating a wooden workpiece. Preferably, a hollow shaft has an inner, cylindrical wall 90 forming an inner chamber sized to allow bar stock and workpieces to be longitudinally fed through the chamber. Thus, a headstock/tailstock assembly 80 having a frameless motor with a hollow shaft facilitates automatic longitudinal loading, transfer and unloading of raw stock, workpieces in operation, and finished workpieces by providing a passage or chamber through which the stock or workpiece may be moved. Additionally, the headstock and/or tailstock assemblies 16 and/or 18 may hold the workpiece in a non-lifting manner and apply a predetermined amount of axial holding force to the workpiece. Further, the headstock and/or tailstock assembly 16 and/or 18 may automatically adjust the axial holding force on the workpiece during the machining of the workpiece, thereby accounting for the removal of material and the potential weakening of the workpiece that may bow or break the workpiece.

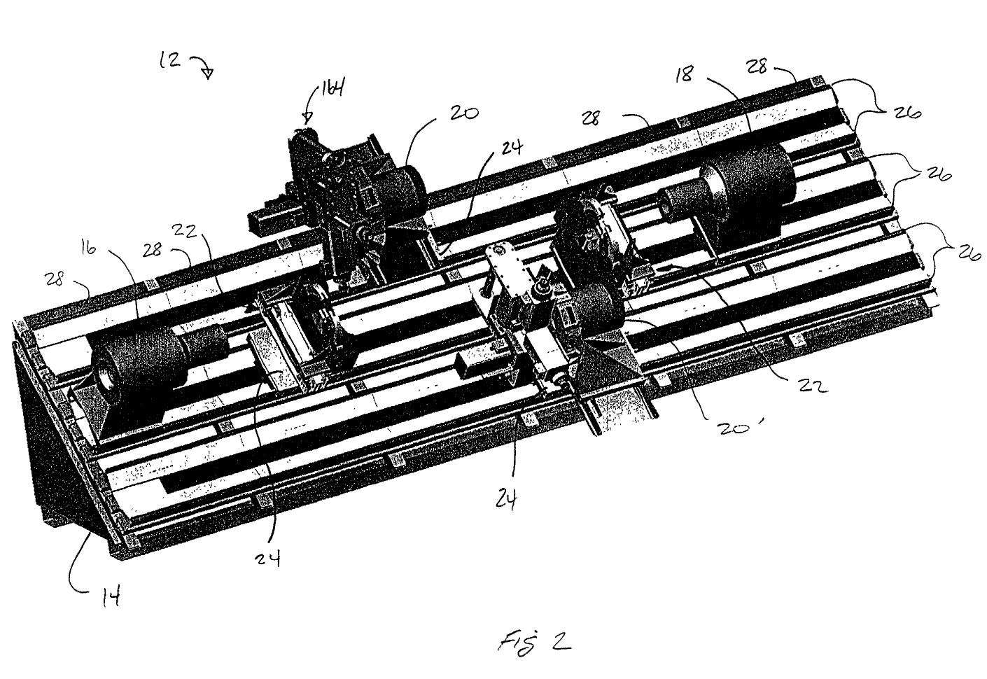

Referring to FIGS. 2 and 14-18, in one embodiment of the present invention, the accessory carrier 22 (FIG. 2) may include one or more accessories for assisting in the machining of the workpiece. Suitable examples of accessories include, but are not limited to, a steady-rest assembly for holding and/or aligning a workpiece, a platform or table assembly for supporting a workpiece, and any other device that may assist in the positioning, holding, machining and loading/unloading of one or more workpieces. The accessory carrier 22 may be mounted on a carriage 24 and move within any predetermined travel path set up on the machine 12. For example, one or more accessory carriers 22 may be positioned between the headstock 16 and tailstock 18. Alternatively, one or more accessory carriers 22 may be positioned beside the tool changers 20 and 20′, or carriers 22 may be positioned on their own predetermined travel path.

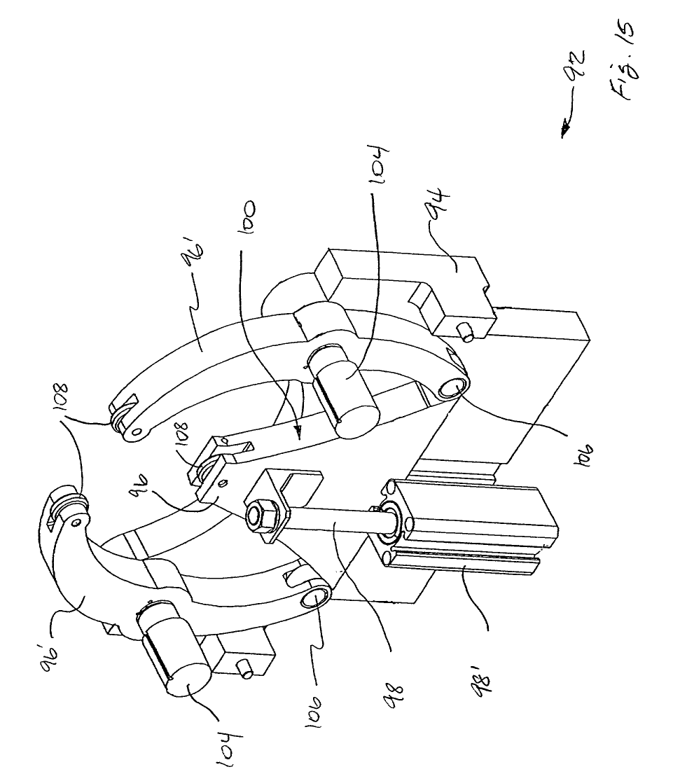

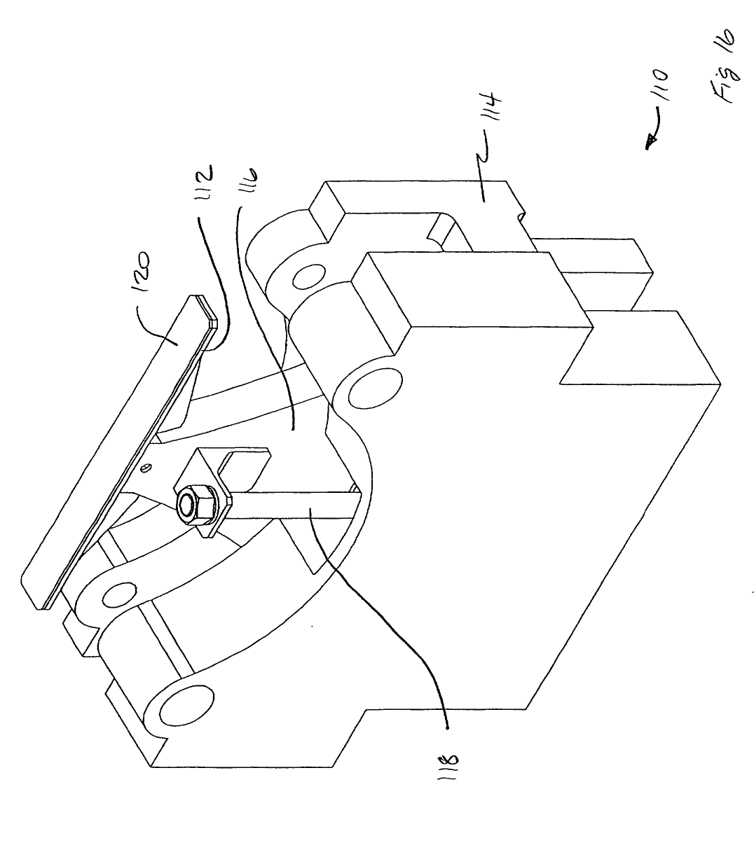

For example, referring to FIGS. 14 and 15, one embodiment of an accessory includes a self-centering steady-rest 92 having a housing 94 that supports arms 96 and 96′, where the arms 96 and 96′ are movable to hold and center a workpiece. The housing 94 may include, for example, opposing plates forming a chamber therebetween for containing the arms 96 and 96′. For example, arm 96 may be a center arm attached to a shaft 98 of a piston 98′ that raises and lowers the position of the arm. Arm 96 may include a cam body 100, and arms 96′ may be pivotally biased against the cam body 100, for example, with a biasing mechanism 102 such as a spring, causing the arm 96′ to rotate about a pin 104 thereby biasing a cam follower 106 against the cam body 100. The cam follower 106 may include, for example, a roller, a ball bearing, a flat surface, a rounded surface, a smooth surface, a piece of low-friction material such as a plastic, etc. As such, the upward/downward movement of the cam body 100 causes the arms 96 and 96′ to open/close to center and hold or release a workpiece. Further, the ends of arms 96 and 96′ may include workpiece holding and/or supporting devices 108, such as a roller, a rounded end, a flat end, an end having cushioning or gripping devices attached thereto, or any other structure that would aid in holding and locating a workpiece.

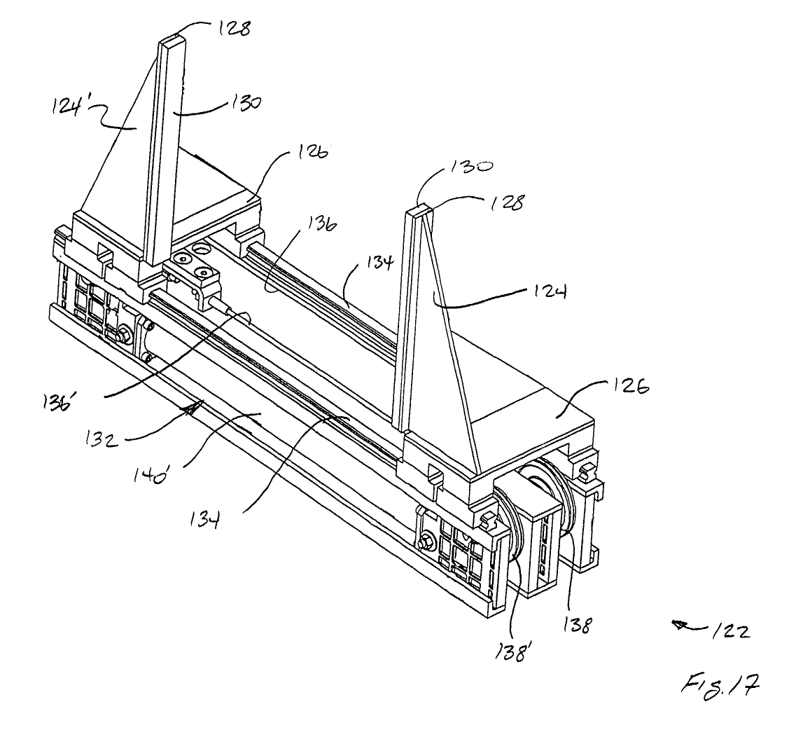

Referring to FIG. 16, another embodiment of an accessory includes a table assembly 110 having a table 112 movably supported within a housing 114. The table 112 may be mounted on a movable arm 116 attached to a shaft 118 of a piston (not shown). The movement of the shaft 118 allows for the precise up and down positioning of table 112 with respect to the machine 12. The table 112 may be fixed or rotatable to maintain any angle with respect to the assembly or the machine 12. Preferably, however, the table 112 is fixed at an angle such that the surface of the table is parallel to the plane of the mounting surface of the machine 12. The table 112 may further include a protective layer 120 so that the surface of a workpiece is supported without damaging the finish. For example, the protective layer 120 may be made from a material such as rubber, plastic, an elastomer, or other similar materials that may provide cushioning and/or protection against marring of a workpiece's finish. In one embodiment of the present invention, the table assembly 110 may include some of the same modular/interchangeable components used in the self-centering steady-rest 92 (FIGS. 14 and 15), such as the housing, the arm, the piston and shaft. For example, referring to FIGS. 14 and 15, the pins 104 may be removed from the housing 94, thereby allowing the arms 96′ to also be removed. Similarly, the workpiece holding device 108 attached to arm 96 may be removed and replaced with the table 112 (FIG. 16). Thus, the table assembly 112 may be mounted to a carriage 24 to provide a support, movable both longitudinally and in/out of a given plane, for use in the operation of the machine 12.

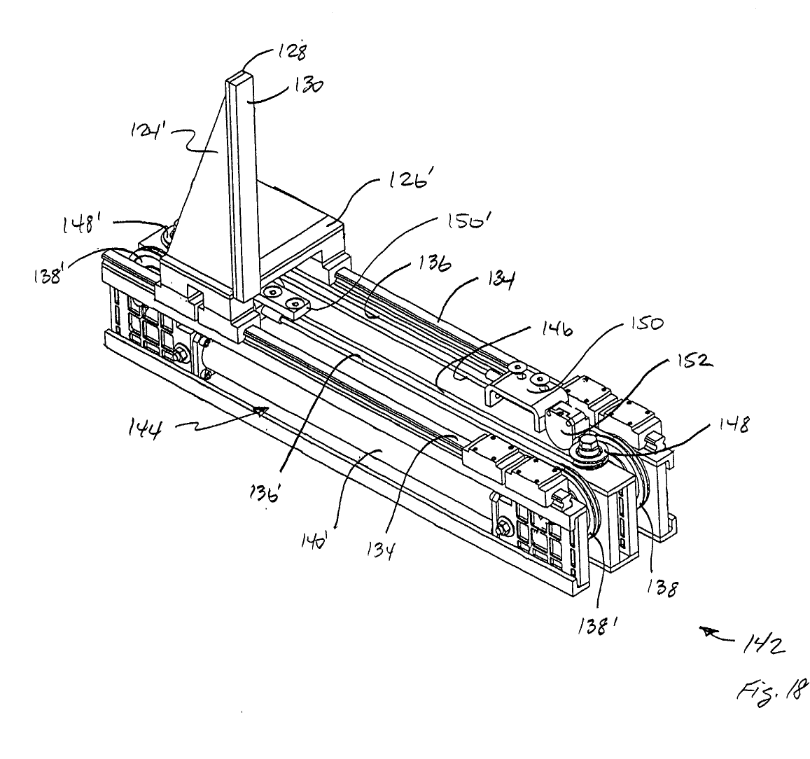

Referring to FIG. 17, yet another embodiment of an accessory includes a steady-rest assembly 122 that includes opposing jaws 124 and 124′ movably mounted on carriages 126 and 126′. The opposing jaws 124 and 124′ may move in tandem to hold a workpiece or other component in a self-centering fashion with respect to the headstock-tailstock axis. Alternatively, the jaws 124 and 124′ may move independently to provide a variable alignment and/or self-alignment feature for the holding of a workpiece or component with respect to the headstock-tailstock axis. Each jaw 124 and 124′ may have an engaging surface 128 and 128′ that may optionally include a protective layer 130. For example, the protective layer 130 may be made from a material such as rubber, plastic, an elastomer, or other similar materials that may provide cushioning and/or protection against marring of a workpiece's finish. The carriages 126 and 126′ are movably attached to a positioning mechanism 132. For example, the carriages 126 and 126′ may move along a guided path 134, such as provided by a track, a channel, rails, or any other structure that contains the movement of the carriages. Each carriage 126 and 126′ may be supported within the guided path 134, such as by the carriage body, bearing blocks, wheels, bearings, rollers, etc.

Suitable examples of a positioning mechanism 132 include, for example, pistons, gears, cable assemblies, linear drive motors, servo-motors, channels, rails, etc. In one embodiment, for example, the positioning mechanism 132 includes a first set and a second set of components independently associated with each carriage 126 and 126′. Each set of components includes a cable 136 (and 136′) running through a set up pulleys 138 (and 138′), one pulley mounted at each end of the steady-rest assembly 122, and having opposing ends attached to opposing ends of a piston 140 (not shown)(and 140′). Suitable examples of pistons 140 and 140′ include, for example, pneumatic pistons, hydraulic pistons, magnetic pistons, rodless pistons, etc. Further, a motor and/or motor and gear combination may be used in place of pistons 140 and 140′. In this embodiment, the movement of the pistons 140 and 140′, and thus the carriages 126 and 126′ and jaws 124 and 124′, may be independently controlled, or they move be moved in concert, thereby providing a self-locating clamp or a self-centering clamp, respectively.

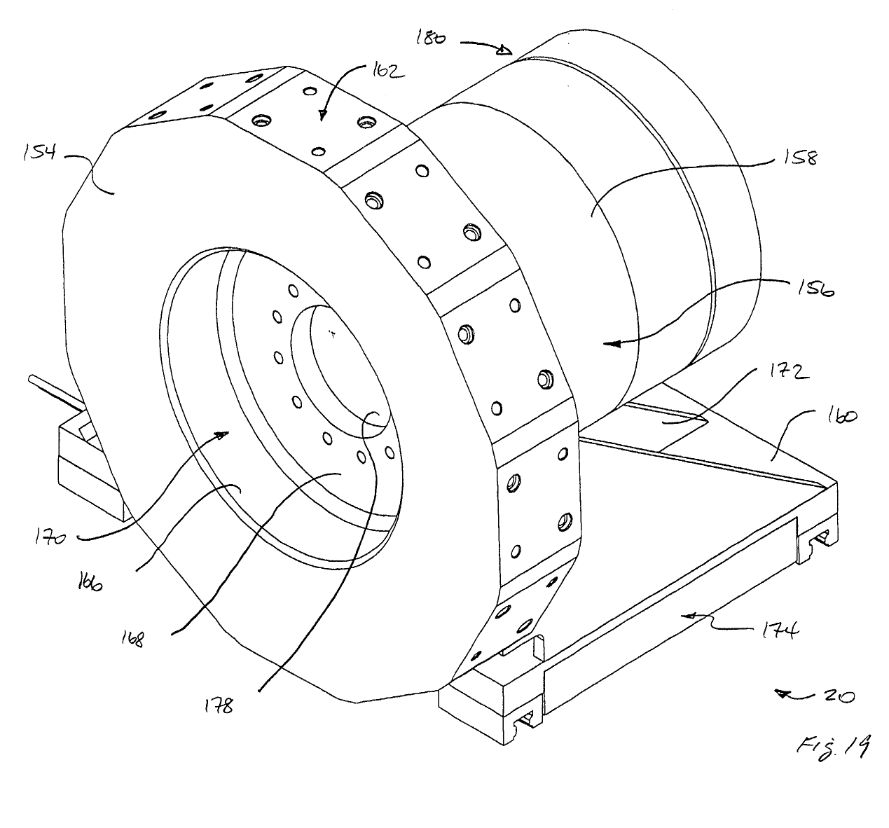

Referring to FIG. 18, still another steady-rest embodiment includes a steady-rest 142 having opposing jaws 124 and 124′ (jaw 124 not shown for clarity) attached to movable carriages 126 and 126′ (carriage 126 not shown for clarity) controlled by a dual self-aligning/self-centering positioning mechanism 144. In one embodiment, the positioning mechanism 144 includes the cables 136 and 136′, pulleys 138 and 138′, and pistons 140 and 140′ described above. Further, the positioning mechanism 144 may include a third cable 146 forming a loop and rotating about opposing pulleys 148 and 148′, where the third cable is fixedly attached to one carriage 126’ and removably attached to the other carriage 126 (not shown) through attachment mechanisms 150′ and 150, respectively. A third piston 152 is fixedly attached to attachment mechanism 150, and has an open position and a closed position for respectively not engaging and engaging the third cable 146. For example, when third piston 152 is in the open position, the third cable 146 freely passes by the piston 152 and through the attachment mechanism 150, thereby allowing independent movement of carriages 126 and 126′. In contrast, when third piston 152 is in the closed position, the piston 152 clamps the third cable 146 so that the carriage 126 moves together with the third cable 146. As such, in the closed position, the third piston 152 connects all of the cables 136, 136′ and 146 and thus both of the carriages 126 and 126′, requiring equal and opposite movements of each piston 140 and 140′ in order to move the carriages, which move equal amounts and thus may provide a self-centering clamping capability. Suitable examples of third piston 152 include any short-stroke cylinder, a pneumatic cylinder, a hydraulic cylinder, etc., such as those manufactured by FestoUSA Corporation.

In a self-aligning mode, for example, to clamp a curved end of a workpiece that does not lie along the center of the headstock/tailstock axis, each piston may move each carriage/jaw until a predetermined resistance is achieved. Upon achieving the predetermined resistance, the corresponding piston does not move the associated carriage/jaw, while the opposing piston moves its associated carriage/jaw to clamp the workpiece in the off-center location. For example, in one embodiment, a shaft-less piston may have a combination of valves, such as a multi-position intake/exhaust valve and a no-return valve attached to one end or both ends of the piston, such that once the predetermined resistance is achieved the piston does not receive any more moving pressure and resists exhausting any pressure to thereby hold the piston, and thus the carriage/jaws, in place. Then, when release of the workpiece is desired, the multi-position valve is moved to an exhaust position that permits the piston to move and unclamp the workpiece.

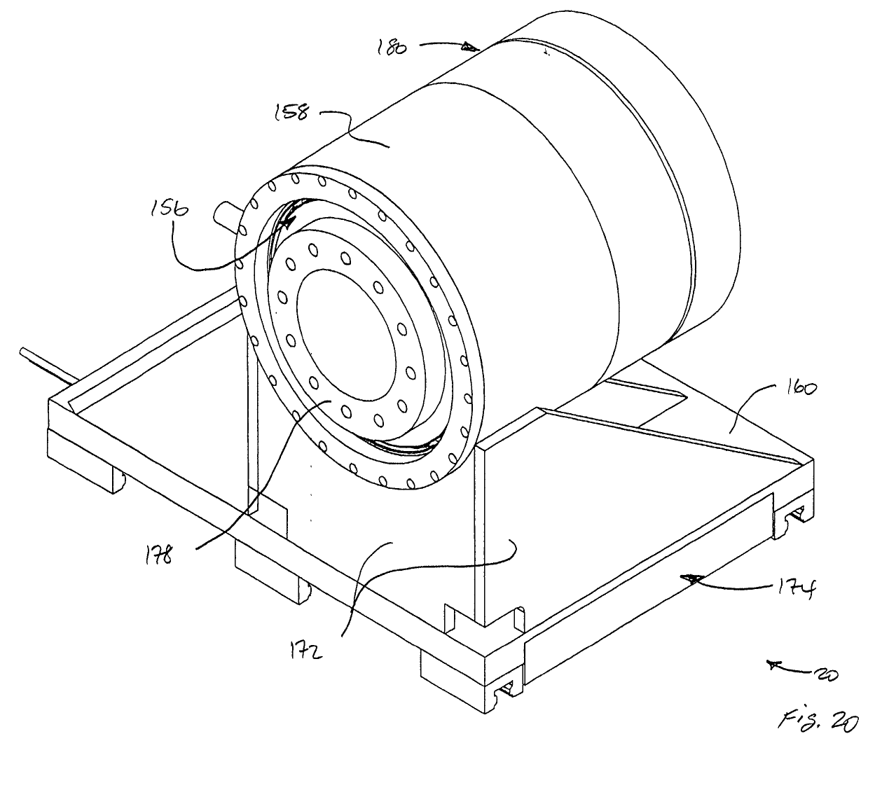

Referring to FIGS. 19-22, one embodiment of a tool changer 20 includes a turret member 154 rotatably mounted to a motor 156 supported within a housing 158 attached to a base 160. As mentioned above, the tool changer 20 may be affixed to a carriage 24 (FIG. 1), such as through the base 160, that moves within a predetermined travel path. Additionally, the tool changer 20 may be movably mounted onto the carriage 24 such that the tool changer moves independently of the carriage 24, as is discussed below in more detail. The turret member 154 may be a substantially disc-like member having a plurality of mounting positions 162 for removably attaching any one of a plurality of tools 164 (FIGS. 1-3), such as by using brackets or other attachment devices. For instance, the mountable tools may include, but are not limited to, standard woodworking tooling for performing longitudinal, axial, radial and angular milling, drilling, facing, turning, sanding, etc. Additionally, the mountable tools may include accessories, similar to those mounted on the accessory carrier 22, such as clamps and holding and/or positioning devices used to help in the operation of system 10. Alternatively, the mountable tools may include individually motorized tools utilizing a router-type motor attached to each individual tool to enable each tool to achieve the rotation speed necessary to efficiently machine a non-metallic workpiece, such as wood. Each mounting position 154 may include a flat surface 162 and a mounting mechanism 164, such as bores or alternatively projecting bolts, for securing the tool to the position. Additionally, the turret member 154 may have an inner axially-extending wall 166 and an inner radially-extending wall 168 forming an inner chamber 170. The inner radially-extending wall 168 interacts with an attachment mechanism, such as bolts or the like, to secure the turret member 154 to the motor 156. Additionally, the chamber 170 provides clearance and reduces the rotational inertia of the turret member 154, thereby reducing the tool changing time and increasing the operational speed of machine 12.

The base 160 may include a number of brace members 172 for supporting the motor 156, housing 158, and turret member 154. Additionally, the base 160 may include a positioning mechanism 174 or associated attachment mechanisms that allow for the movement of the tool changer 20 with respect to the carriage 24 to which it is attached. For example, in one embodiment, the positioning mechanism 174 may include bearing blocks, rollers, bearings, guides, rods, channels, etc. for allowing and guiding the movement of the tool changer 20. Additionally, for example, the positioning mechanism 174 may include components of a drive system, such as an electro-magnetic linear drive, a magnetic drive, a gear drive, a piston drive, and any other similar type of controllably positional drive system. In one preferred embodiment, a magnetic, direct drive, linear motor is utilized. Further details of the positioning mechanism 174 are discussed below. Suitable materials for forming the base 160, housing 158, and brace members 172 include metals, composites, and other similar materials able to withstand the forces, weights, acceleration and vibration of the tool changer 20.

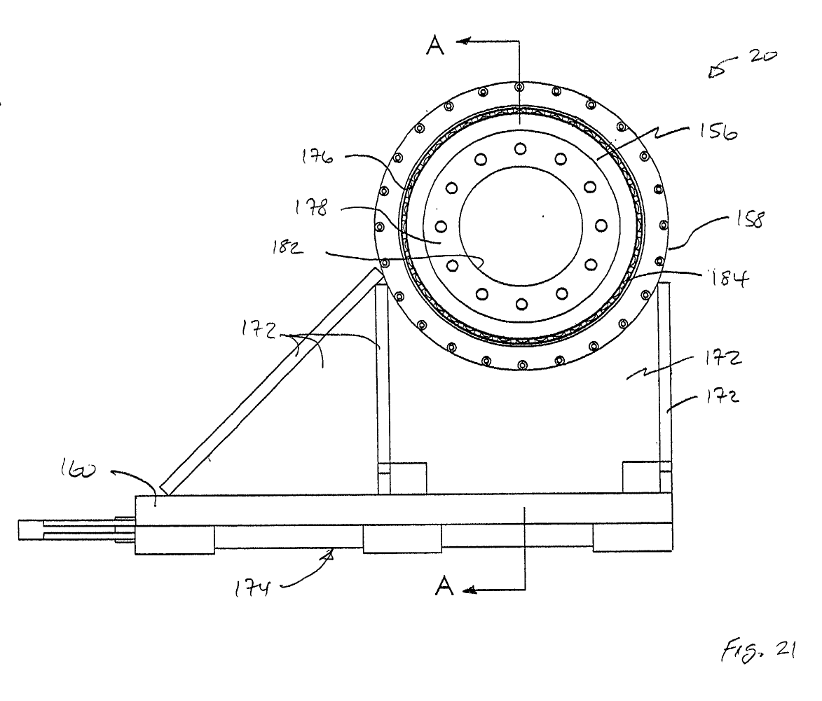

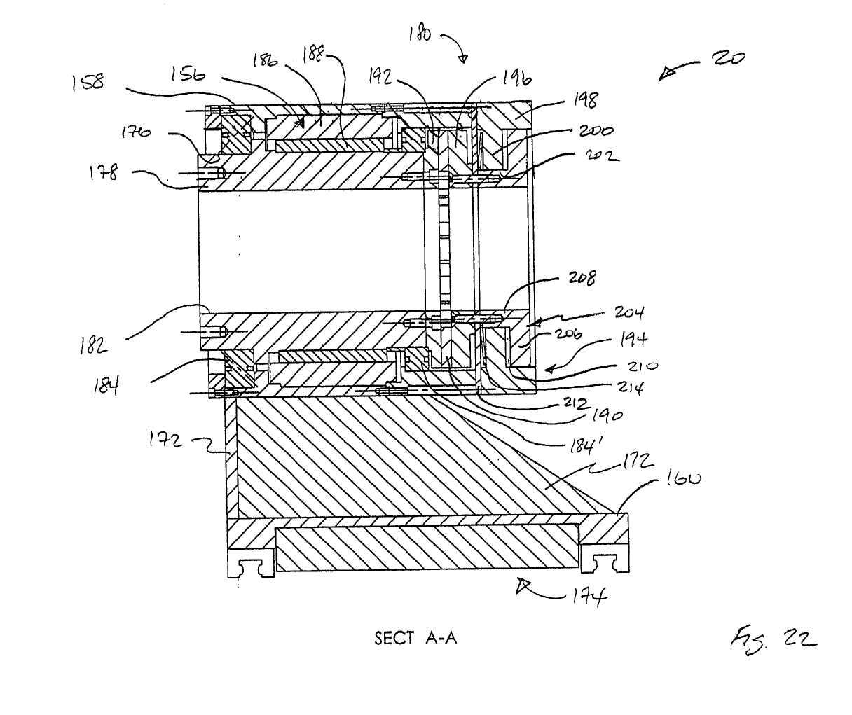

Referring to FIGS. 21 and 22, the motor 156 is fixed within an inner chamber 176 within the housing 158 and includes a rotatable shaft 178. At least one end 178′ of the shaft 178 is adapted for mounting the turret member 154, while the other end 178″ may be adapted to engage a braking system 180. The braking system 180, as is discussed in more detail below, may be separate from or integral with the motor 156 and reduces the speed and/or stops the rotation of the shaft 178, insuring that the shaft 178 maintains a fixed, angular position, without allowing for backlash, when the braking system 180 is engaged. Suitable examples of a motor 156 include electro-magnetic motors, electric motors, magnetic motors, servo-motors, frameless motors, and any other type of motor capable of rotating at speeds suitable for changing tools, i.e. in the range of about 0.01 to about 0.7 seconds for about a 30° rotation, more preferably in the range of about 0.1 to about 0.5 seconds for about a 30° rotation, and capable of being accurately indexed to a given rotational position. Preferably, the motor 156 is servo-motor, such as a light-weight, frameless, digital servo-, direct-drive motor manufactured by Kolmorgen. Further, the rotation of the motor 156 does not need to be locked/braked during machining operations on the workpiece, i.e. the rotation of the motor 156 may be used as an axis of the machine to perform work.

The shaft 178 may be a solid shaft or a hollow shaft, preferably formed from a material, such as a metal, able to withstand the high forces involved with holding and rotating a wooden workpiece. Preferably, the shaft 178 includes a hollow shaft having an inner, cylindrical wall 182 forming an inner chamber sized to reduce the mass of the shaft 178, thereby reducing the rotational inertia of the shaft 178.

Referring to FIG. 22, in one embodiment, the motor 156 is supported by front and rear bearing assemblies 184 and 184′, respectively, mounted within the housing 158. The motor 156 includes a stator 186, such as a cylindrical wound wire, fixedly attached to the housing 158 and a rotor 188, such as a cylindrical magnetic assembly, fixedly attached to shaft 178 and concentric with the rotor 188. The stator 186 is radially spaced apart from the rotor 188 such that energization of the stator 186 creates a magnetic field that forces the rotation of the rotor 188 and shaft 178 relative to the stator 186 and housing 158.

As mentioned above, a braking system 180 that does not allow for backlash or play is associated with the motor 156. The braking system 180 may be integral with the motor 156, or it may be adapted to work in combination with the motor 156. A suitable example of a braking system 180 includes, but is not limited to, disc-brake systems, drum brake systems, magnetic brake systems, electronic brake systems, pneumatic systems, hydraulic systems, mechanical coupling systems, etc. The braking system 180 engages the motor 156, such as through the shaft 178, in a non-rotatable fashion to thereby brake the rotation of the shaft 178 without any rotational play.

For example, the braking system 180 may include a braking component attached to a fixed structure that does not allow for rotational play of the braking component. As such, when the braking component engages the rotating shaft, or other motor component associated with the rotating shaft, with enough force to stop the rotation of the shaft, the shaft is held in non-rotatable position, such as a position that does not allow for any amount of rotational play. In one embodiment, for example, the braking system 180 includes a friction disk associated with the shaft 178 and a plate attached to a piston that engages and disengages the disk to stop the rotating shaft. The braking system 180 also includes an anti-rotation mechanism to prevent the piston from rotating when the plate contacts the rotating shaft. In particular, referring to FIG. 22, the braking system 180 includes a friction disk 190 attached to shaft 178, such as through a brake plate 192. Suitable examples of the friction disk 190 may include, but are not limited to, friction brake materials, brake linings, etc. A piston assembly 194 having a base plate 196 that is engagable with the rotatable shaft 178 may be axially-aligned with the shaft and attached to the housing 158. The piston assembly 194 has an outer cylinder 198 with one end having a flange 200 with cylindrical walls 202 forming an opening. A piston 204 having a piston head 206 and cylindrical shaft 208 is disposed with the cylinder 198, where a fluid or gas chamber 210 is formed between the opposing walls of the flange 200 and the piston head 206. The fluid or gas chamber 210 may contain any fluid, such as oil, gas, etc. Appropriate sealing devices, such as elastomer washers and o-rings, may be used to seal the fluid within the chamber 210. A fluid or gas source (not shown) is connected to the fluid chamber 210 and a controller may control the pressure of the fluid within the chamber 210 to move the piston assembly 194 within the cylinder 198. The base plate 196 for engaging friction disk 190 may be attached to the end of the shaft 208 opposite the piston head 206. A fluid or gas reservoir (not shown), referred to as a pressure accumulator, and a quick exhaust system may be added for faster activation of the brake.

The non-rotating mechanism my include a diaphragm member 212 positioned between the base plate 196 and the shaft 208, where the diaphragm member 212 may also be fixedly attached between the cylinder 198 and the housing 158 to prevent rotation of the base plate 196 and shaft 208 upon engagement with the rotating shaft 178. Alternate non-rotating structures, such as a coupling assembly having interacting, geared components, one attached to the rotating shaft and one attached to the piston, may also be used to prevent rotation of the brake assembly with respect the rotating shaft. Diaphragm member 212 may be biased toward the shaft 178 by a biasing member 214, such as a spring or Belleville washer, positioned between the diaphragm member and the flange 200. As such, the diaphragm member 212 is formed of a resilient material, such as a spring steel, having a predetermined spring force or resistance to flexing that is less than a predetermined spring force of the biasing member 214 to allow the diaphragm member/biasing member to bias the base plate 196 against the friction disk 190 without allowing any angular play. Similarly, when actuating the piston assembly 194, the chamber 210 has a predetermined pressure greater than the combination of the predetermined spring force of the biasing member 214 and the predetermined spring force of the diaphragm member 212 to move the base plate 196 out of contact with the friction disk 190 and allow rotation of the shaft 178. Thus, the braking system 180 is positively biased in a first position to stop rotation of the shaft 178 and hold the shaft in a non-rotatable position without allowing for any angular play, and is energizable to move into a second position that allows rotation of the shaft. The positive biasing to the first position also enhances the safety of the system, as a failure within the braking system, such as a pressurization failure in the chamber, results in the rotation of the shaft being stopped by the positive biasing of the piston assembly into the first position to brake the shaft. Further, another feature of this embodiment of braking system 180 is that the non-rotatable diaphragm member 212 allows shaft 178 to be stopped at any angular position, as opposed to having to lock the shaft in a predetermined angular position. Thus, the non-rotatable braking mechanism engages the shaft, such as in an axial direction, to stop the rotation of the shaft and hold the shaft in any angular position without any angular play or backlash.

As mentioned above, the tool changer 20 may be movably mounted to the carriage 24 (FIG. 1) so as to be independently movable with respect to the carriage 24. For example, the tool changer 20 may include a movable mount or positioning mechanism that provides for rotation or linear movement in any direction, such as up, down, longitudinally, transversely, angularly, etc., with respect to the carriage 24. The movable positioning of the tool changer 20 allows the associated operational tool from the plurality of tools 164 to be adjustably positioned with respect to the carriage 24, for example to perform work on a workpiece mounted between the headstock and tailstock.

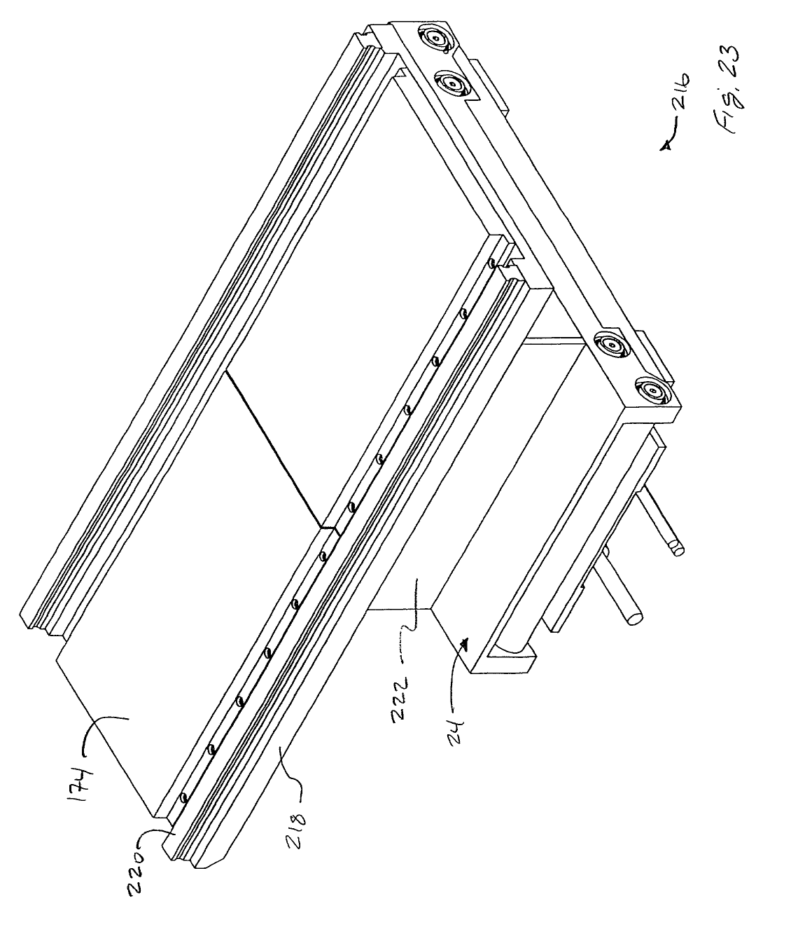

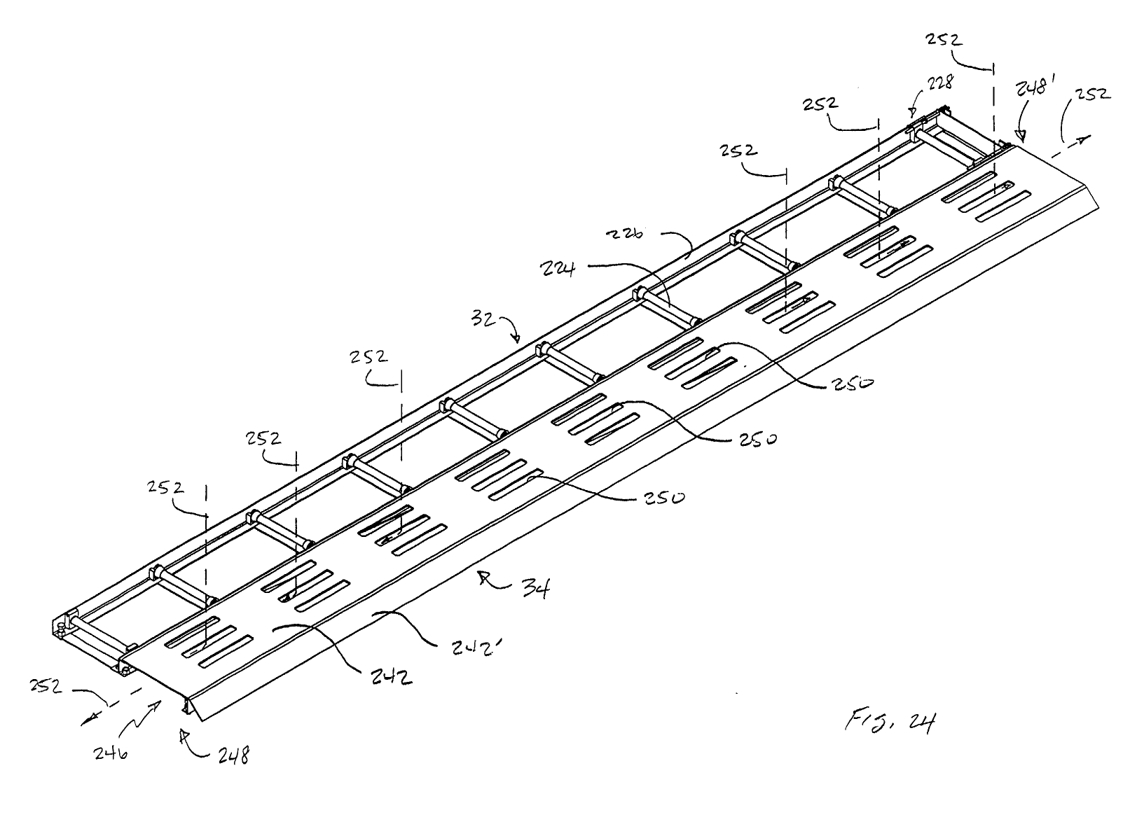

Referring to FIG. 23, for example, one embodiment of a mount 216 for movably securing tool changer 20 includes a track 218 forming a predetermined travel path along which the tool changer may be positioned. A suitable example of a track 218 includes, but is not limited to, a set of rails 220, a channel, rods, and other similar supporting structures provided a guided path. Mount 216 may operate in conjunction with positioning mechanism 174, as discussed above, which may be attached to mount 216, to tool changer 20, or to combinations of both. Additionally, mount 216 may include a positioning member 222 for locating track 218 in a predetermined position relative to, for example, carriage 24 and/or headstock/tailstock axis. Positioning member 222 may provide a fixed or a variable position and orientation of track 218. Suitable examples of positioning member 222 include a spacer block, a piston assembly capable of raising/lower/rotating the track, a scissor-legged structure, and other similar structures.

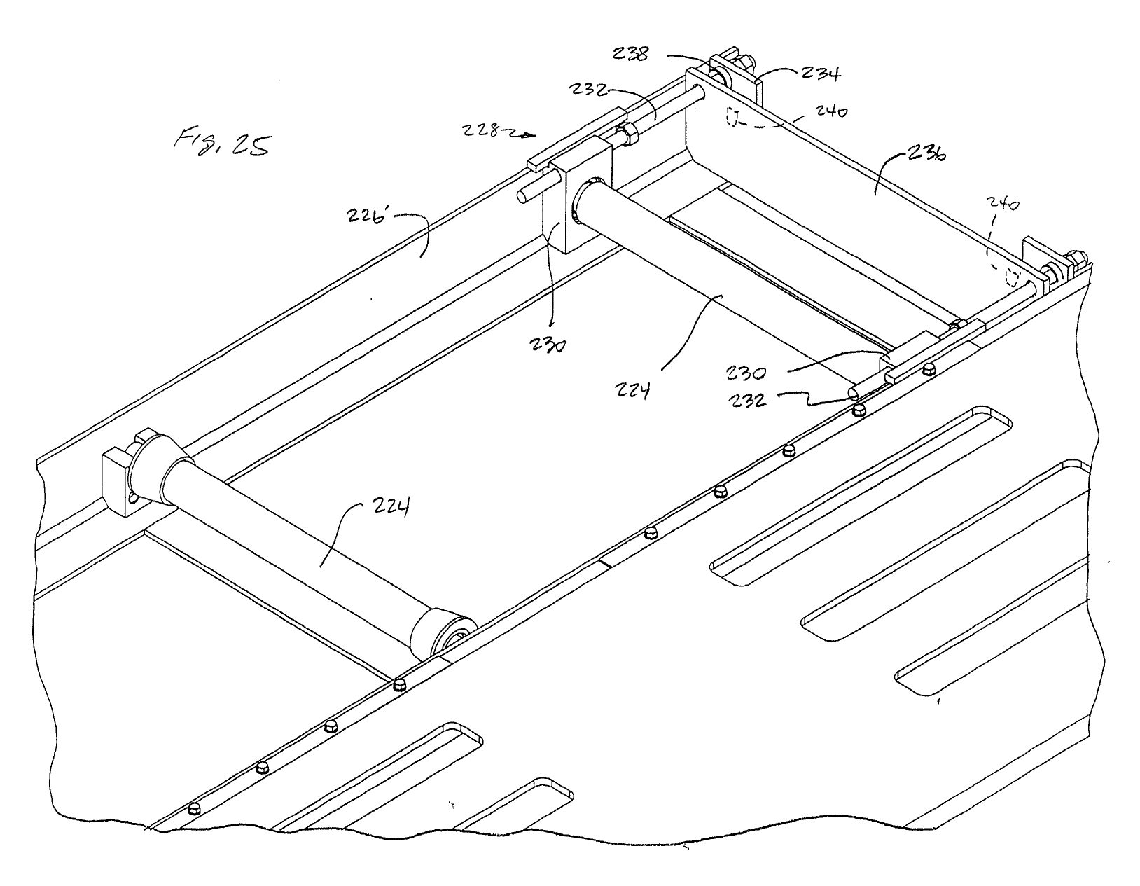

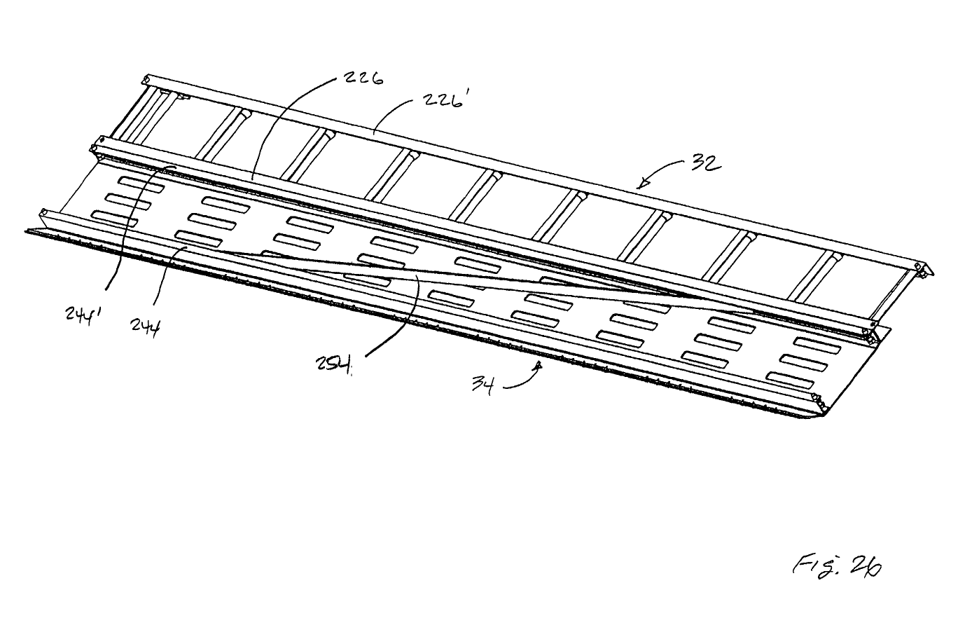

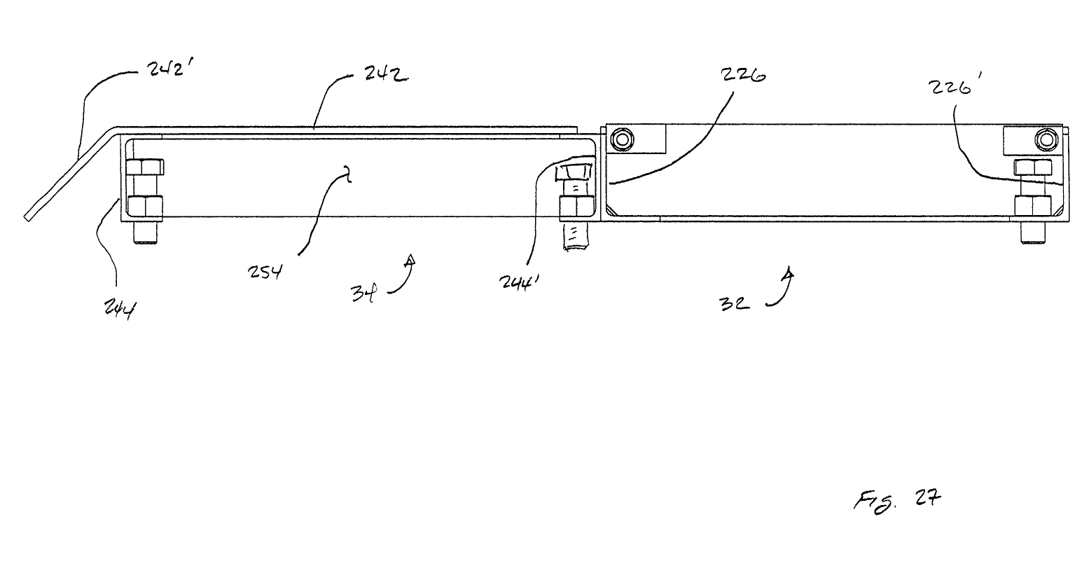

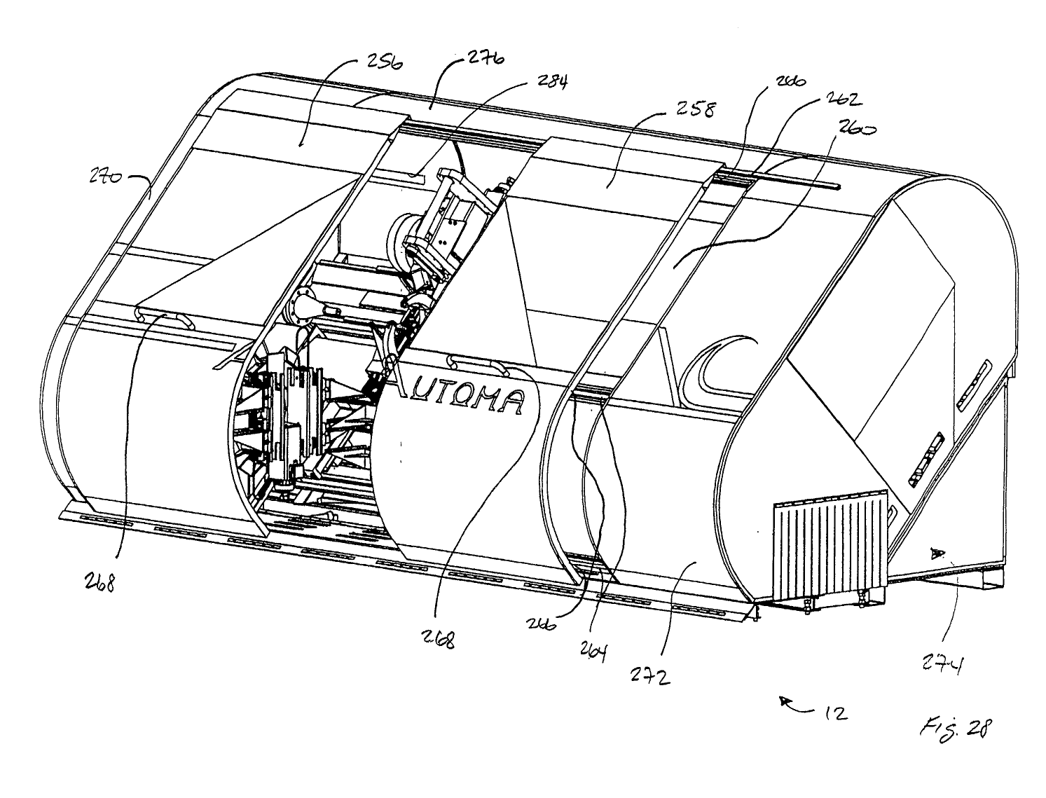

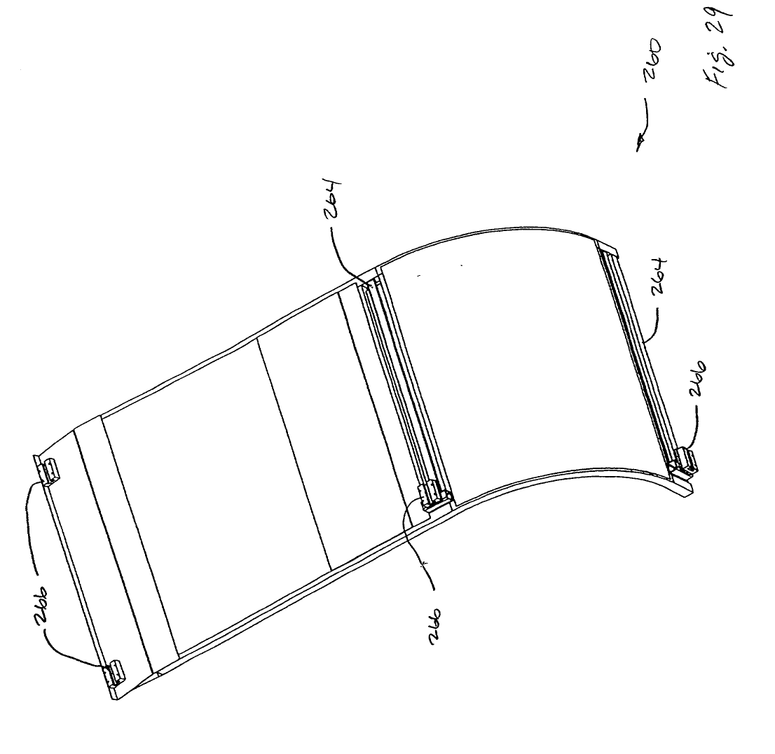

Referring to FIGS. 24-27, in one embodiment, conveyor assembly 32 is positioned adjacent to platform 34 at the front of the machine 12. Conveyor assembly 32 and platform 34 may be independently secured in position, such as by an attachment mechanism anchored to a floor, or dependently secured together. Conveyor assembly 32 includes a plurality of longitudinally spaced-apart rollers 224, supported by front and back frame members 226 and 226′, the rollers 224 supporting a belt (not shown) that forms a longitudinally-extending loop around the rollers 224. A motor (not shown) may connect to one or more rollers 224 or to the belt to drive the belt over the rollers 224 at a predetermined velocity, which may be controlled in a variable fashion.

Referring to FIGS. 24 and 25, conveyor assembly 32 may also include a tensioning device 228 located at one or both ends for providing the belt with a predetermined tension. For example, tensioning device 228 may include a roller 224 supported at each end in a bearing block 230 that is slidingly mounted to frame member 226 or 226′. Further, a rod 232 is fixedly attached to each bearing block 230 at one end, with a stop member 234 fixedly attached to the opposing end, where each rod is slidingly supported by an intermediate frame member 236 fixedly secured to front and back frame members 226 and 226′. A biasing mechanism 238, such as a spring or beveled washer, is disposed between stop member 234 and intermediate frame member 236 and biases the roller 224 toward the end of the conveyor assembly 32, thereby tightening the belt. Biasing mechanism 238 has a predetermined spring force sufficient to generate a predetermined tension within the belt.

Additionally, a safety mechanism 240 may be positioned between intermediate frame member 236 and stop member 234, where the stop member includes a plate fixed to the rod 232. Safety mechanism 240 includes, for example, a switch that provides a signal to stop the conveyor assembly 32 if a predetermined distance between the stop member 234 and intermediate frame member 236 is achieved, such as if an operator were to stand on the belt. It should be noted that a safety switch may be elsewhere located to detect a load on the belt or to detect if the belt has broken.

Platform 32 includes a plate 242 horizontally positioned and supported by vertically-oriented front and back frame members 244 and 244′. Platform 32 may also include front member 242′ angularly positioned between plate 242 and a supporting surface such as a floor. Plate 242 may be formed of any metal, plastic, composite material, or any other material capable of supporting the weight of one or more operators, and/or workpieces, and/or tooling components, etc. Plate 242, front and back frame members 244 and 244′, and the supporting surface such as the floor define a chamber 246 having open ends 248 and 248′. Additionally, plate 242 may have a plurality of internal walls 250 defining opening to chamber 246. A vacuum device (not shown) may be connected to each open end 248 and 248′ to remove air from chamber 246. The combination of the vacuum devices and interior walls/openings 250 of plate 242 create a directional airflow 252 to collect dust and other airborne debris resulting from the machining of the workpiece. The directional airflow 252 starts from inside of the machine housing 40, passing through interior walls 250, then through chamber 246 and out of the machine 12 to a dust collection system. Optionally, one or more dividers 254, such as a metal plate, may be fixed within chamber 246 to divide the chamber to increase the efficiency of the airflow. Divider 254 may be fixed in any position, such as longitudinally, transversely, or angularly within chamber 246.

As mentioned above, referring to FIGS. 1, 3 and 4, machine housing 40 includes a plurality of covers and movable doors. Housing 40 may be formed from solid or composite panels of material. For example, housing 40 may be formed from metals, plastics, composite materials, etc. Housing 40 may include a predetermined sound suppression characteristic, resulting from a structure that substantially encloses machine 12 and dampens sound produced by the machine. For example, each cover and door of housing 40 may substantially sealingly engage adjacent covers/doors to substantially retain sound and airflow within the housing. Adjoining covers/doors may include cushioning elements or flexible elastomeric or plastic elements to variably fill any gaps between the adjoining covers/doors. Further, for example, the covers/doors of housing 40 may include a composite structure having an inner and outer spaced-apart panels, with a sound-absorbing material such as foam filling the space between the panels. The inner surface of the inner panels may additionally include another layer, integral with the inner panel or a separate layer applied to the inner panel, having a sound-deadening structure or formed from a sound-deadening material.

Additionally, the doors of housing 40 may form a variable-sized opening for accessing machine 12. For example, the opening may be adjusted to the minimum size necessary for loading and unloading a workpiece or system component, thus reducing the amount of noise and dust/debris that may escape from within housing 40.

Further, housing 40 may include various other openings, such as: to allow components to enter one side or the other side of the conveyor assembly; to allow a vacuum system to access the chamber underneath the platform; to allow an air system to provide airflow underneath the covers covering the predetermined travel path of the carriages, as well as to provide additional air inputs into the housing, as is discussed below; to allow stock or workpieces to be axially-fed into the headstock or out of the tailstock; and to allow any other access required for system operation to the machine. Any openings may be removably covered with flexible or rigid materials, such as with a sliding or hinging door or with flexible strips of material such as downwardlyhanging and overlapping plastic strips.

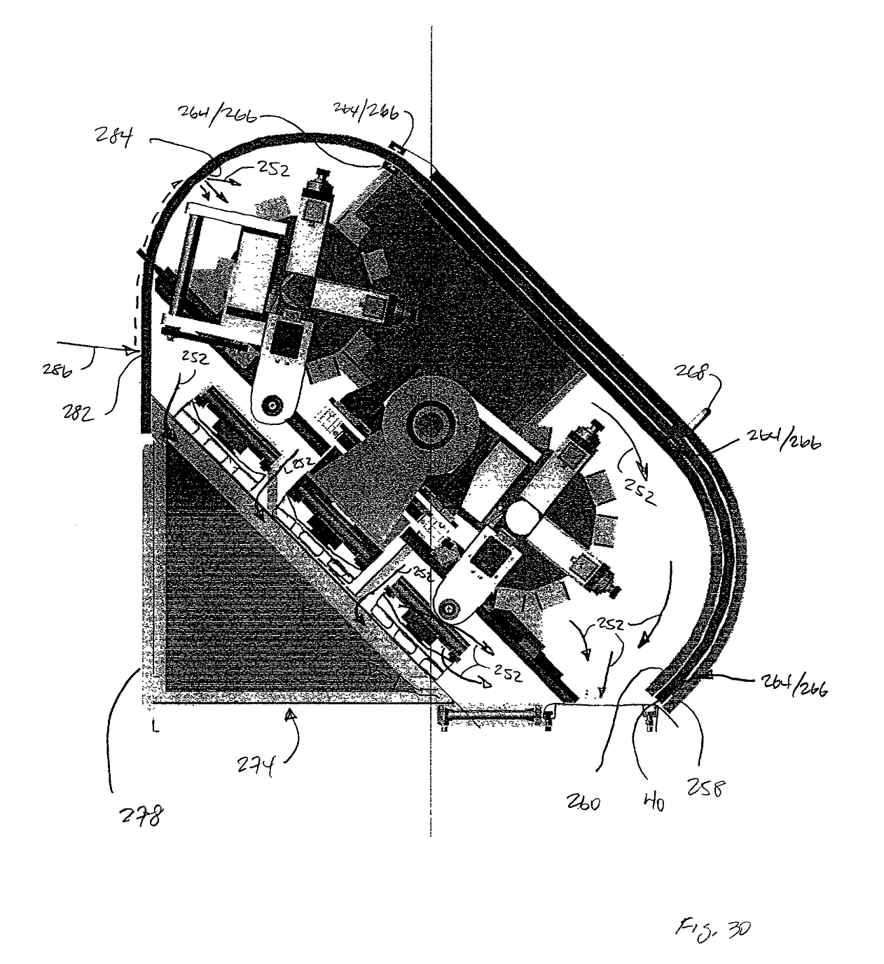

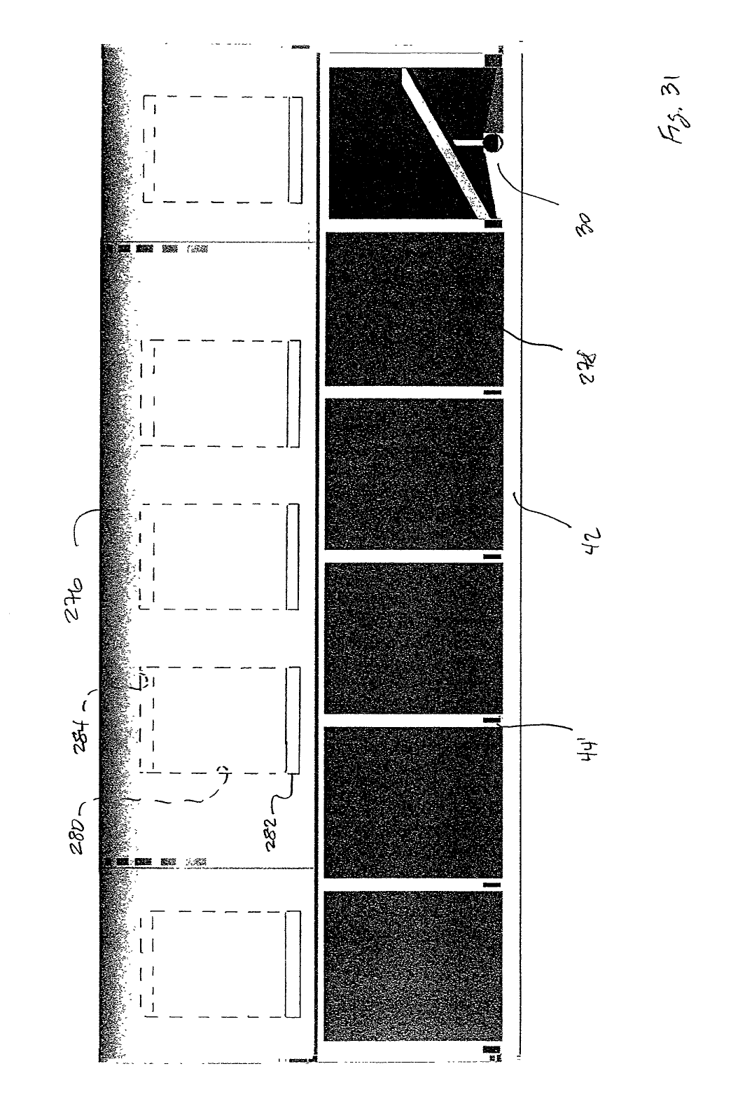

Referring to FIGS. 28-31, in one embodiment, housing 40 includes a left and right outer door 256 and 258, respectively, and an inner door 260 slidingly mounted to a support structure on housing 40, such as rails 262. Rails 262 may be longitudinally positioned anywhere across the height of the door, for example at the top and bottom ends of the doors and/or across the middle of the door. Further, inner door 260 and right outer door 258 may be slidingly connected to each other through rails 264 mounted on the outer surface of the inner door. Rails 264 may further connect to a bearing block 266 mounted on the inner surface of the housing adjacent to inner door 260 such that the inner door may be slidingly supported inside one end of the front cover of the housing. Likewise, in other locations, bearing blocks 266 may be mounted to housing 40 and/or doors 256, 258 and 260 in combination with the rails to slidingly support the doors.

The sliding movement of right outer door 258 may control the sliding movement of inner door 260. For example, the left end of the rails connecting inner door and right outer door may include a stop such that when right outer door is in a first, fully-closed position, a block on the outer door catches the stop to insure that the inner door is also in a fully-closed position. Further, the right outer door may have a stop positioned at its left end and in line with the inner door stop, and protruding to catch the inner door stop, such that when the right outer door is in a second position, fully overlapping the inner door, any subsequent sliding to the right to a third, fully-opened position, causes the outer door stop to catch the inner door stop and sliding move the inner door along with the right outer door.

The left and right outer doors 256 and 258 each may include handle 268 protruding from or recessed within the door to assist in the opening and closing of the respective door.

Housing 40 may include various, preferably modular, fixed covers at the front, sides, and back of machine 12. For example, the removable, fixed covers may include front covers 270 and 272, one or more end covers 274, top/back covers 276 and back bottom covers 278.

The covers, such as top/back covers 276, may further include one or more internal air chambers 280 each having an air input 282 and an air output 284 for creating a directional airflow 252 within housing 40, as discussed above in relation to platform 34. Air input 282 includes an opening on the outside of a cover, the input connected to an internal chamber. Air output 284 includes an opening on the inside of a cover, the output connected to an internal chamber. Optionally, a directional device such as a flange-like device, which may be variably controllable, may be attached to air output 284 to directionally control the deliver of the air from the output. A supply of air 286 may be connected to the inputs 282 to provide the directional airflow 252 to collect and control airborne debris and air quality. The combination of inputs, outputs, internal chambers, and vacuum devices that create directional airflow 252 comprise an airflow and debris-containing system. The vacuum devices connected to, for example, the platform and the dust collector funnel assemblies, and, for example, the air supply system connected to the covers at the internal chambers and at the carriage mount ends, may be separate systems or a single, integrated system involving filtering the vacuum-collected air and debris and recirculating the filtered air, possibly in combination with fresh air. This type of air flow system may be internal to system 10, external to system 10, or combinations of both.

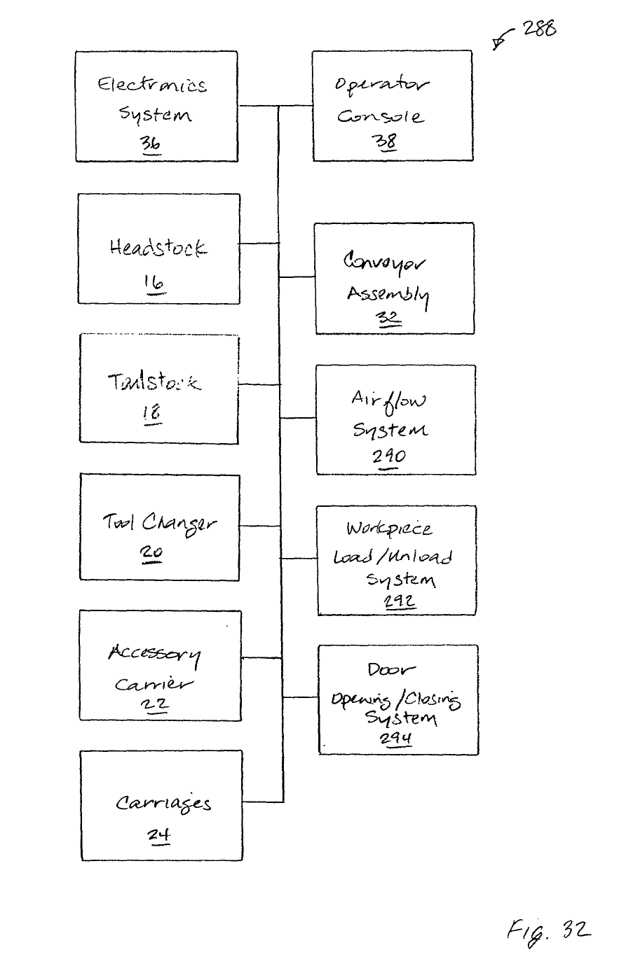

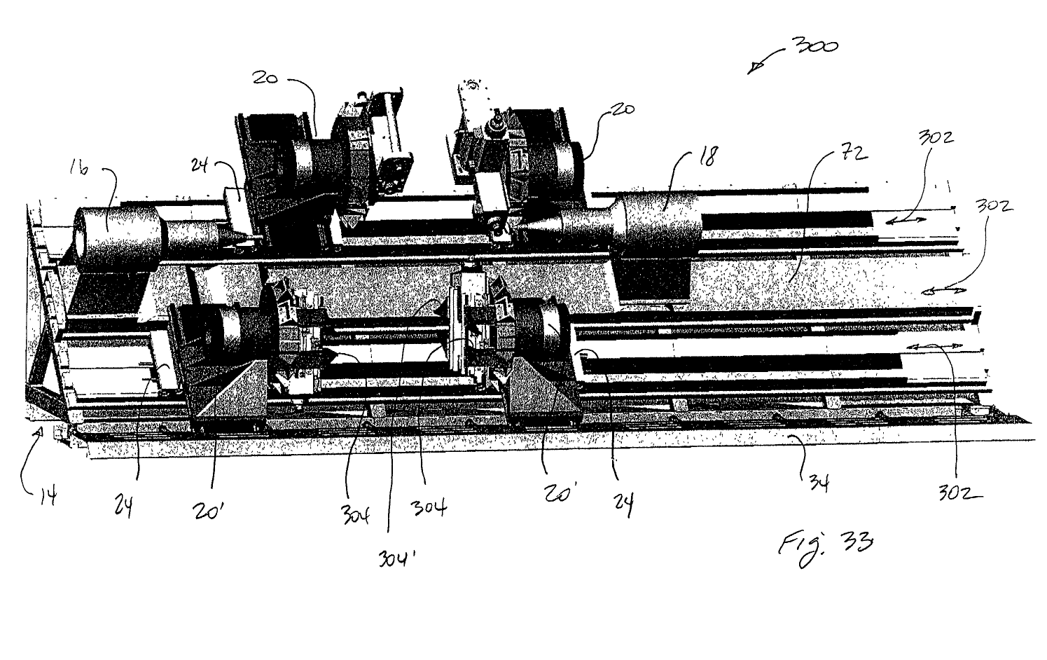

Referring to FIG. 32, electronics system 36 and operator console 38 manage a control and feedback system 288 that operates system 10. Electronics system 36 and/or operator console 38 may be locally mounted to machine 12 or remotely positioned for remote operation. Electronics system 36 and operator console 38 include the appropriate circuitry, processing and storage capability and associated electronics to operate machine 12. Further, for example, electronics system 36 and operator console 38 may include display devices such as a monitor, input/output devices such as virtual or non-virtual keyboards and printers, and audio speakers/microphones for receiving and outputting audible signals.

Additionally, electronics system 36 and/or operator console 38 may include or be in communication with artistic carving software, such as Raindrop Geomagic® software, and a laser digitizer. This type of artistic carving software, in combination with the laser digitizer, allows system 10 to perform 3-dimensional laser digitization of any surface contour and auto-program machine 12 to duplicate the surface contour. This allows system 10 to fabricate a workpiece that includes, for example, a “hairypaw” type base to a chair leg. Other carving-type surfaces may also be digitized and fabricated by system 10.

Control and feedback system 288 may simultaneously provide control signals to one or more of the components of system 10, may simultaneously receive feedback signals indicating a status of one or more predetermined characteristics of one or more system components, and may simultaneously process the feedback signals and generate a revised control signal that may be simultaneously sent to one or more system components to change the predetermined characteristic. For example, the control and feedback system 288 may individually or simultaneously control: the rotational speed of headstock 16 and tailstock 18; the tool indexing of one or more tool changers 20; the movement and positioning of each tool changer mount 216 relative to their corresponding carriages; the operation of any accessories on the accessory carrier 22; the movement and positioning of the plurality of carriages 24; the operation of conveyor assembly 32; the operation of one or more of the plurality of tools 164; the operation of an airflow system 290, as described above; the operation of an automatic workpiece loading and unloading system 292, including the supply of the workpiece stock and the packaging of the workpiece stock; the operation of an automatic door opening/closing system 294 for the housing doors; and other similar control systems that may be associated with the operation of machine 12.

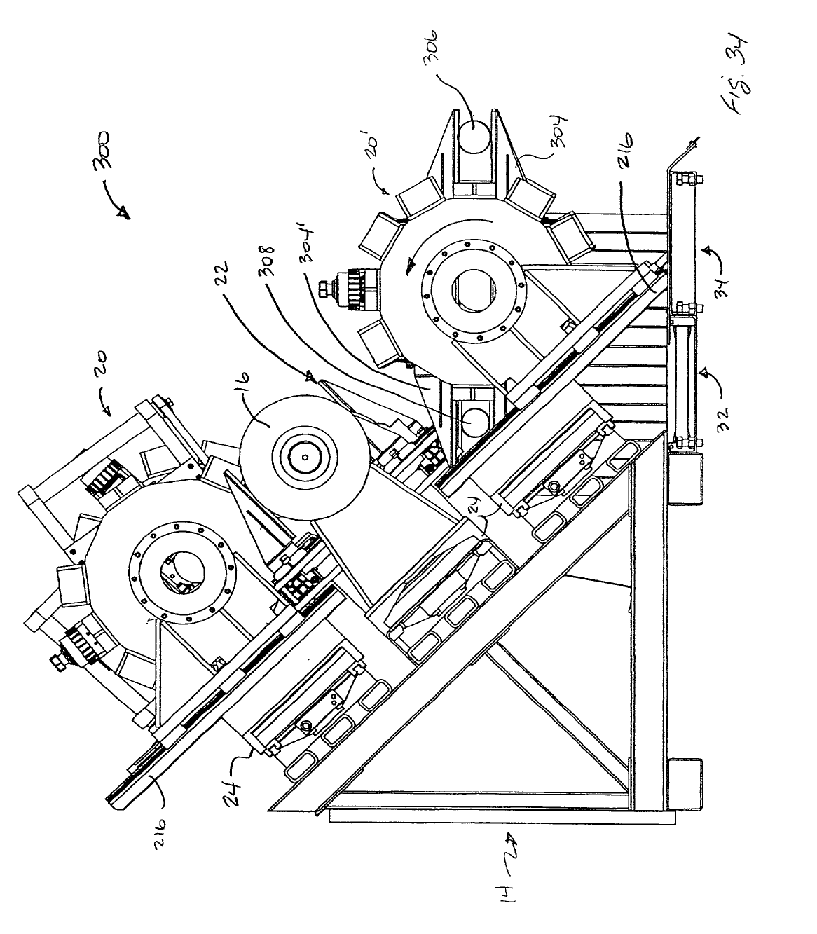

Referring to FIGS. 33 and 34, another embodiment of a workpiece machining system includes a machine 300 that is similar to machine 12, but that includes a total of four tool changers 20. In this embodiment, each pair of tool changers 20 and 20′ are mounted on opposing sides of the headstock/tailstock axis, mounted on carriages 24 that are movably positionable within predetermined travel path 302. Each of tool changers 20′, positioned near the bottom of machine 300, includes at least one clamping tool 304, and alternatively two clamping tools 304 and 304′, that is capable of holding and releasing a workpiece, such as a raw workpiece 306 for automatic loading and a finished workpiece 308 for automatic unloading of the machine. Each clamping tool 304 may be fixedly or movably affixed to a tool changer. If fixedly attached to the tool changer, the clamping tool may be positioned by the variable positioning of the movable mount 216 supporting the tool changer. For example, an automatic supply system may convey a quantity of raw workpieces 306 into a position where each raw workpiece may be grasped by the one or both clamping tools 304. Tool changer 20′ may then rotate the raw workpiece 306 around and position the raw workpiece in the headstock/tailstock axis, or alternatively into a position to be supported by an accessory on accessory carrier 22, so that the raw workpiece can be secured in the machine and operated upon. While raw workpiece 306 is being machined, tool changer 20′ may rotate back and clamping tools 304 may pick up another raw workpiece 306. Once the machining is complete, then tool changer 20′ may rotate clamping tools 304′ into position to remove finished workpiece 308 and rotate around to, optionally, simultaneously unload finished workpiece 308 and load the next raw workpiece 306. It should be noted that the automatic loading/unloading may be sequential or simultaneous operations. Therefore, clamping tools 304 and 304′ mounted on tool changers 20 and 20′, alone or in combination with accessories mounted on accessory carrier 22, may form an automatic load/unload system that does not require any other fixturing. Thus, by providing tool changers with workpiece holding devices, such as clamping tools, the present invention allows for automatic loading and unloading of the machine without the need for special fixturing devices.

In summary, the present invention includes machining systems and methods having a headstock, tailstock, accessory carriers, and tool changers having a plurality of tools, each mounted on carriages movably mounted within guides supported on a machine bed. The machining systems and methods provide a multi-function, multi-axis machine operable for machining any surface of a non-metallic workpiece, including each end. Some features of the present invention include: the angled bed supporting the machining components, which allows for debris to be collected by gravity and which efficiently packages the machine components into a compact design within a given space, and which further increases accessibility to the machine for an operator; a modular design that may be customized to provide a working envelope that accommodates any sized workpiece; a high performance computerized control and feedback system and drive systems to maximize the speed of the system components to correspondingly minimize dead time in the processing of a workpiece; frameless spindles and linear motors that permit controlled workpiece rotation, and a corresponding machine base to accommodate the high forces created by these components; a plurality of automatic tool changers with high tool changing speeds; stationary tools and rotary tools mountable to the tool changers to perform a plurality of operations on the workpiece; the automatic loading and unloading capability provided by the tool changers, clamping tools, accessories, headstock and tailstock; the airflow system including integrated dust collection plates, funnel assemblies and airflow inputs to collect the dust/debris created during the machining process; the cover over the guide assembly to prevent the accumulation of dust/debris in the travel path of the carriages; a guide assembly, carriage and cover design that allows for a plurality of carriages to move within the same travel path; the ability to perform more than one operation on one workpiece at one time, or different operations on two different workpieces at one time; the braking assembly associated with the tool changer that includes no rotational play or backlash; Slant bed machine-base with integrated dust chutes and dust suction hoods; slant bed machine design for ergonomics, compactness, dust handling and simplified loading unloading procedures; slant bed machine-base design for large work piece capacity within a compact design and low tool/accessories interferences; slant bed machine-base, 45 degrees for ease of manufacturability; slant bed machine-base design for modular construction; slant bed machine-base allowing multiple machine tooling/accessories configuration; slant bed machine design to accept multiple tool changers sharing the same rail configuration; automatic programmable tool changer, tool changing time of 0.3 seconds or less; automatic tool changer is also a machine axis capable of several machining and auxiliary operation; tool changer directly driven by a machine CNC axis; tool changer with axial passage for auxiliary accessories; tool changer capable to accept stationary tools, live tools, axial tools, radial tools, sanding tools, axial sanding belt, radial sanding belt, sanding brushes either rotary or stationary, adjustable tools, work piece grippers for axial or radial operation; multiple tool changers of the same type may be outfitted on the same machine; brake with no backlash 2000 Nm pneumatically, hydraulically, or electromechanically/electro magnetically activated; instantaneous engaging/disengaging without braking element movement; machine covers with integrated air flow for dust control; machine covers with noise control; machine covers, which allows from, top and side loading; telescoping automatic machine doors with selectable opening option; chip conveyor with integrated dust suction; removable chip conveyor; stationary guide covers; stationary guide covers with integrated air/vacuum flow; stationary cover/protection for magnetic field; guide cover for high speed operation; guide cover for multiple tables/slides sharing the same covers and rail; automatic self centering work piece rest 355 mm diameter to 0 mm; automatic self centering work piece rest with integrated work table; self-centering and self-locating work piece clamp; accessory carries capable simultaneously carrying the self-centering rest, self centering-locating clamps and follow rests without work piece and/or tooling interferences; interchangeable headstock and tailstock; tailstock which is controlled by CNC for opening, positioning and work-piece clamping; headstock, tailstock with integrated axial passage, cullet chucks, jaws-chucks, vacuum chucks, spur chucks, live center chucks; headstock and tailstock with quick release of workholding devices; automatic variable diameter drive spur; headstock, tailstock and multiple accessory tables sharing the same machine axis and rails; accessory tables are capable to retract under headstock or tailstock independently; accessory tables are capable of relocating during the work cycle; automatic loading and unloading integrated in the machine design, max 1.5 seconds for complete unloading and reloading cycle; automatic loading and unloading which will self center and locate the work piece without operator intervention for set up; automatic loading/unloading of random size pieces both lengths wise, thickness wise and width wise without operator intervention; machining center, which is capable of longitudinal turning, face turning, milling with axial or radial tools, milling with axially adjustable tools, turning with fixed or rotary tools, drilling and boring longitudinally-axially or at an angle, sanding longitudinally and/or radial utilizing belts or brushes and utilizing rotating or stationary sanding mediums; machining center, which is capable of performing multiple operations simultaneously on one or more than one work piece face; machining center, which is capable of machining all 6 faces of a work piece, within the same machine and without operator intervention; possibility to have separate loading and unloading clamps on turrets for faster cycles; possibility of up to 4 independent turrets on the same machine, 48 tools; possibility to program multiple loading/unloading cycles and positions; possibility to load/unload from any type of chuck system (spur, vacuum, 4 jaws, 3 jaws, collect, etc.) without the need for auxiliary systems, like expellers, burr pullers, centering devices, etc.

Exemplary embodiments of the present invention have now been described in detail. It will be appreciated that these embodiments are merely illustrative of the present invention and are in no way intended to be limiting. Variations in and modifications to the present invention will be apparent to those of ordinary skill in the art and the following claims are intended to cover all such equivalents.

What is claimed is:

1. A machining system for forming a non-metallic part, the machining system comprising:
a headstock assembly and a tailstock assembly, the headstock assembly and the tailstock assembly being axially aligned along a headstock-tailstock axis, the headstock assembly and the tailstock assembly together operable for rotatably supporting the part;
a base operable for movably supporting the headstock assembly and the tailstock assembly;
a plurality of tool changers movably coupled to the base, each of the plurality of tool changers comprising a plurality of tools operable for machining surfaces of a workpiece and forming the part; and
a controller operable for directing the machining system to form the part.

2. The machining system of claim 1, further comprising at least one accessory carrier movably coupled to the base, the at least one accessory carrier comprising at least one accessory operable for assisting in the loading, stabilizing, and unloading of the part.

3. The machining system of claim 2, further comprising a plurality of guide assemblies extending longitudinally across the base.

4. The machining system of claim 3, further comprising a plurality of carriages operable for moving along the plurality of guide assemblies.

5. The machining system of claim 4, wherein the headstock assembly, the tailstock assembly, the plurality of tool changers, and the at least one accessory carrier are coupled to the plurality of carriages.

6. The machining system of claim 1, wherein the plurality of tool changers comprise a first tool changer positioned on a first side of the headstock-tailstock axis.

7. The machining system of claim 6, wherein the plurality of tool changers comprise a second tool changer positioned on a second side of the headstock-tailstock axis.

8. The machining system of claim 1, further comprising at least one collector plate operable for collecting debris generated by the forming of the part.

9. The machining system of claim 1, wherein the controller comprises system electronics operable for directing the system to form the part and an operator console operable for allowing an operator to direct the system electronics.

10. The machining system of claim 1, further comprising a housing enclosing components of the machining system.

11. The machining system of claim 10, wherein the housing comprises a noise insulation material.

12. The machining system of claim 2, wherein the at least one accessory comprises a steady-rest assembly comprising a plurality of jaws coupled to a plurality of movable carriage devices, the steady-rest assembly operable for clampingly holding the workpiece in a self-centering manner with respect to the headstock-tailstock axis.

13. The machining system of claim 1, further comprising a conveyor assembly operable for transporting debris generated by the machining system away from the machining system.

14. The machining system of claim 13, wherein the conveyor assembly is operably coupled to an external vacuum system.

15. A machining system for forming a non-metallic part, the machining system comprising:
a headstock assembly and a tailstock assembly, the headstock assembly and the tailstock assembly being axially aligned along a headstock-tailstock axis, the headstock assembly and the tailstock assembly together operable for rotatably supporting the part;
a base operable for movably supporting the headstock assembly and the tailstock assembly;
at least one accessory carrier movably coupled to the base, the at least one accessory carrier comprising at least one accessory operable for assisting in the loading, stabilizing, and unloading of a workpiece;
a plurality of tool changers movably coupled to the base, each of the plurality of tool changers comprising a plurality of tools operable for machining surfaces of the workpiece and forming the part; and
a controller operable for directing the machining system to form the part.

16. The machining system of claim 15, further comprising a plurality of guide assemblies extending longitudinally across the base.

17. The machining system of claim 16, further comprising a plurality of carriages operable for moving along the plurality of guide assemblies.

18. The machining system of claim 17, wherein the headstock assembly, the tailstock assembly, the plurality of tool changers, and the at least one accessory carrier are coupled to the plurality of carriages.

19. The machining system of claim 15, wherein the plurality of tool changers comprise a first tool changer positioned on a first side of the headstock-tailstock axis.

20. The machining system of claim 19, wherein the plurality of tool changers comprise a second tool changer positioned on a second side of the headstock-tailstock axis.
